(19) United States
(12) Patent Application Publication
(10) Pub. No.: US 2026/0266954 A1
(43) Pub. Date: Sep. 10, 2026

(54) Methods and Systems for Radar Signal Processing Using Temporal Neural Networks with State-Space Model

(71) Applicant: BrainChip, Inc., Laguna Hills, CA (US)

(72) Inventors: M. Anthony Lewis, La Jolla, CA (US); Amir Mohammad Naderi, Laguna Niguel, CA (US); Olivier Jean-Marie Dominique COENEN, PhD, Encinitas, CA (US); Yan Ru PEI, Irvine, CA (US); Kristofor D. Carlson, Willoughby Hills, OH (US); . Sidharth, Laguna Hills, CA (US); Ritik Shrivastava, Aliso Viejo, CA (US)

(21) Appl. No.: 19/559,695

(22) Filed: Mar. 6, 2026

Related U.S. Application Data
(60) Provisional application No. 63/768,443, filed on Mar. 7, 2025.
(60) Provisional application No. 63/770,270, filed on Mar. 11, 2025.

(51) Int. Cl. G01S 7/41; G06N 3/0455; G06N 3/049

(52) U.S. Cl. CPC G01S 7/417; G06N 3/0455; G06N 3/049

(57) ABSTRACT

Embodiments disclosed include methods and systems for signal processing using temporal neural networks integrated with state space models (SSMs). A computing system may receive radar signals, including in-phase and quadrature baseband samples, and extract features using an SSM that captures information associated with phase, frequency, amplitude, and signal structure. The system may generate a modified radar signal that includes temporal dependencies, downsample the modified radar signal to generate an intermediate representation, and provide the intermediate representation to a classifier to automatically identify a modulation type associated with the radar signal. Some embodiments include an SSM-based encoder-decoder architecture for real-time processing of audio signals including speech signals. The architecture may generate a denoised output signal for real-time enhancement of raw input signals on edge devices with reduced latency and memory requirements.

### RELATED APPLICATIONS

This application claims the benefit of priority to U.S. Provisional Patent Application No. 63/768,443 entitled “Methods and Systems for Radar Signal Processing Using Temporal Neural Networks with State-Space Model” filed on Mar. 7, 2025 and U.S. Provisional Patent Application No. 63/770,270 entitled “Methods and Systems for Radar Signal Processing Using Temporal Neural Networks with State-Space Model” filed on Mar. 11, 2025, the entire contents of both of which are hereby incorporated by reference for all purposes.

### GOVERNMENT INTEREST

This invention was made with government support under grant number FA875025CB013 awarded by the U.S. AirForce. The government has certain rights in the invention.

### BACKGROUND

Radio Detection and Ranging systems support defense, aviation, weather forecasting, maritime navigation, autonomous vehicles, and remote sensing. These systems transmit radio frequency (RF) signals and measure reflections from targets to determine distance (range), velocity, and angle. Radar performance depends on sophisticated signal processing that may operate in real time, often under difficult conditions.

Common radar tasks include target detection, automatic modulation classification (AMC), and clutter rejection. These tasks may require computational efficiency, accuracy, and tolerance to interference from noise, jamming, or multipath reflections. Older approaches often used matched filtering, Doppler processing, or statistical methods. Though effective in certain scenarios, these methods sometimes degrade in dynamic or interference-heavy settings. There is a demand for more advanced radar signal processing strategies that handle long-range dependencies, function efficiently, and adapt to changing conditions.

### SUMMARY

The various aspects include methods for adaptive control of a radar system based on modulation-type identification from digital in-phase and quadrature (I/Q) baseband samples, the method performed by a computing system coupled to a radar receiver and a radar controller, which may include receiving, by the computing system, a radar signal comprising digital I/Q baseband samples, generating, by the computing system and with a state space model (SSM), an intermediate sequence comprising SSM output features that represent temporal dependencies of the digital I/Q baseband samples, downsampling, by the computing system, the intermediate sequence by applying a learned downsampling transformation that reduces a sequence length and maps input channels to output channels to form a downsampled intermediate representation, generating, by the computing system, a classifier output by providing the downsampled intermediate representation to a classifier, identifying, by the computing system and from the classifier output, a modulation type associated with the radar signal, and updating, by the computing system, the radar system by generating radar-control data that specifies at least one of a threshold setting, a dwell allocation, a waveform schedule, and an assignment of resource priority and by providing the radar-control data to the radar controller.

Some aspects include methods of processing radar signals, performed by a computing system having one or more processors and one or more memories, which may include receiving a radar signal, extracting, using a state space model (SSM), a set of features from the radar signal, the set of features which may include information associated with phase, frequency, amplitude, and a structure of the radar signal, generating a modified radar signal that may include temporal dependencies included in structure of the radar signal, downsampling the modified radar signal to generate an intermediate representation of the radar signal, providing the intermediate representation of the radar signal to a classifier to generate an output, identifying automatically, based on the output, a modulation type associated with the radar signal, and sending data to adapt a radar operation, based on the identification of the modulation type associated with the radar signal, the radar operation associated with at least one of a threshold setting, a dwell allocation, a waveform schedule, and assignment of resource priority In some aspects, the generating the modified radar signal may include reducing, using the SSM, a noise associated with the radar signal in the modified radar signal.

In some aspects, the generating the modified radar signal may include identifying if an anomaly may be included in the radar signal, and based on detecting the anomaly, generating a flag indicating the modified radar signal may be associated with a potential interference and/or unauthorized transmission. In some aspects, the classifier may be a SSM encoder, or the SSM may be an autoencoder. In some aspects, the intermediate representation of the radar signal may be generated by an SSM. Further aspects may include a computing device having a processor configured with processor-executable instructions to perform various operations corresponding to the methods discussed above.

Some aspects include methods of analyzing radar signals using a temporal neural network integrated with a state space model, the method which may include receiving in-phase and quadrature baseband samples from a radar receiver, processing the received in-phase and quadrature baseband samples with a temporal neural network that may include a state space model to extract one or more latent representations, generating an output that classifies a modulation type or identifies a target based on the one or more latent representations, and adapting, based on the modulation type or target, a radar operation which may include at least one of adjusting a detection threshold, selecting a waveform from a waveform library, updating a dwell allocation, or modifying a resource priority of the computing system. Some aspects may further include initializing one or more parameters of the state space model by defining at least one transition matrix or at least one observation matrix.

In some aspects, the temporal neural network may include an SSM-based encoder that captures extended temporal correlations in the in-phase and quadrature baseband samples and outputs the one or more latent representations to a classifier head. In some aspects, the classifier head may include one or more fully connected layers that receive the one or more latent representations and produce an output indicating the modulation type or target class. Some aspects may further include converting one or more temporal convolution operations within the temporal neural network into equivalent recurrent operations during inference, reducing memory usage and enabling real-time analysis on embedded hardware. In some aspects, the temporal neural network may include parallelizable matrix operations that update states of the state space model, allowing simultaneous processing of multiple time steps on a graphics processing unit or equivalent hardware accelerator. In some aspects, each labeled example may include a sequence of in-phase and quadrature baseband samples paired with a ground-truth modulation category or target label. In some aspects, the learned projection matrix performs downsampling by mapping an input feature space to a reduced representation that preserves time-dependent features relevant for the classification or detection output. In some aspects, the one or more parameters of the state space model are updated using an optimization procedure that accounts for long-range dependencies in the received in-phase and quadrature baseband samples.

In some aspects, the output that classifies a modulation type or identifies a target may include generating a confidence score that indicates the likelihood of a particular modulation scheme or target class. In some aspects, the radar signals originate from at least one radar platform selected from the group consisting of defence, maritime, weather monitoring, aviation, or autonomous vehicle systems.

Some aspects include a system for processing radar signals. The system may include a processor and a memory. The processor may be configured to receive a signal and extract, using a state space model (SSM) autoencoder, a set of features from the radar signal. The set of features may retain a structure of the radar signal. The processor may be configured to generate a modified radar signal that includes temporal dependencies in the structure of the radar signal. The processor may be configured to downsample the modified radar signal to generate an intermediate representation of the radar signal. The processor may be configured to provide the intermediate representation of the radar signal to a classifier to generate an output. The processor may be configured to identify automatically, based on the output, a modulation type associated with the radar signal.

Further aspects may include a computing device having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIG. 1 is a component diagram illustrating components and operations in a system that could be configured to implement automatic modulation classification (AMC) methods using convolutional neural network (CNN) models, recurrent neural network (RNN) models, or hybrid frameworks in accordance with some embodiments.

FIG. 2 is a component diagram illustrating components and operations in a system that could be configured to implement a training pipeline for temporal neural networks-based radar signal classification in accordance with some embodiments.

FIG. 3 is a graph illustrating exemplary time, frequency, and time-frequency domains, and time-frequency representations of radar waveforms in various modulations and configurations, in accordance with some embodiments.

FIG. 4 is a component block diagram illustrating an example SSM-based encoder and classifier head that is suitable for implementing some embodiments.

FIGS. 5A and 5B are data representations evaluating example results for AMC with a temporal neural network-based encoder classifier in accordance with some embodiments.

FIG. 6 is a process flow diagram illustrating a method for processing radar signals using temporal neural networks with state-space modeling in accordance with some embodiments.

FIG. 7 is a process flow diagram illustrating a method for training and deploying a model for radar signal processing using temporal neural networks with state-space modeling in accordance with some embodiments.

FIG. 8 is a process flow diagram illustrating a method for low-latency processing of radar signals using a temporal neural network with a state-space model in accordance with some embodiments.

FIG. 9 is a process flow diagram illustrating a method for processing radar signals using state-space feature extraction and automatic modulation classification in accordance with some embodiments.

FIG. 10 is a process flow diagram illustrating a method for analyzing radar signals using a temporal neural network integrated with a state-space model in accordance with some embodiments.

FIG. 11 is a flow diagram illustrating an SSM-based encoder-decoder architecture with a downsampling encoder path and an upsampling decoder path for signal processing in accordance with some embodiments.

FIGS. 12A, 12B, and 12C are spectrogram representations comparing a noisy signal, a clean ground truth signal, and a denoised output signal, illustrating signal enhancement using the disclosed systems and methods in accordance with some embodiments.

FIG. 13 is a block diagram illustrating a system configured for signal processing operations including a system-on-chip with processing elements and resources in accordance with some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

The word “exemplary” may be used herein to mean “serving as an example, instance, or illustration”. Any implementation described herein as “exemplary” is not necessarily to be construed as preferred or advantageous over other implementations.

The embodiments include radar signal processing technologies and, more specifically, advanced artificial intelligence (AI) based methods and systems that utilize temporal neural networks integrated with state space models (SSM) to enhance radar operations. The embodiments addresses multiple key radar processing tasks, including automatic modulation classification (AMC) and radar signal detection. Some embodiments may use temporal neural networks, such as Temporal Event Neural Networks (TENNs), with SSMs to provide enhanced temporal modeling for real-time radar operations in diverse environments. The embodiments may use such networks to provide enhanced temporal modeling capabilities for robust, efficient, and real-time processing of radar signals across diverse operational scenarios.

Some embodiments may include a framework for real-time radar signal processing. The embodiments may include a processor-based module that manages in-phase and quadrature baseband data and leverages advanced time-series methods. Some embodiments may implement or use SSM techniques, which may represent time-varying behavior using learned system parameters, and neural network architectures for processing sequential data. Radar signals often exhibit high dimensionality, unpredictable interference, and rapidly changing target motion profiles, which pose challenges for existing digital signal processing solutions that depend on large memory resources or extensive manual preprocessing.

Existing deep learning models often handle local features or short-range dependencies but may degrade performance when the environment changes quickly or when sequences extend over many time steps. Limited computational budgets on embedded hardware also restrict the adoption of architectures with high complexity or large memory footprints. Some embodiments address these constraints by using structured state-space operations in parallel, reducing overhead while preserving long-range temporal information in radar signals. Some embodiments may integrate adaptive downsampling of time-series data with direct raw I/Q input, which may allow faster classification or detection for tasks such as modulation recognition or target identification. The result may be improved real-time performance and reduced power usage in hardware-constrained environments, supporting a wider range of radar sensing applications without sacrificing accuracy.

The term “processing system” may be used herein to refer to one or more programmable processors configured to execute stored instructions. The processing system may include one or more central processing units (CPUs), graphics processing units (GPUs), digital signal processors (DSPs), neural processing units (NPUs), or combinations thereof. The processors may operate independently or cooperatively within a computing device. Methods described herein may be implemented by one or more processors of the processing system.

The terms “machine learning model” and “artificial intelligence model” may be used interchangeably herein to refer to a computational model configured to process input data according to learned model parameters and to generate output data. The machine learning model may include an architecture definition and corresponding model parameters. The architecture definition may specify a computational structure. The model parameters may include learned weights. A machine learning model may include a neural network, a convolutional neural network (CNN), a recurrent neural network (RNN), a state space model (SSM), a deep neural network (DNN), or an ensemble model.

The term “large generative model” may be used herein to refer to a machine learning model configured to generate structured output data from learned representations. A large generative model may include a large language model (LLM), a large speech model (LSM), a vision-language model (VLM), or a multi-modal model. References to a large generative model are provided for definitional completeness and not limit radar embodiments described herein.

The term “neural network” may be used herein to refer to a machine learning model that includes interconnected computational nodes arranged in layers. Each computational node may receive an input value, apply one or more mathematical operations using model parameters, and generate an output value. The output value may serve as input to another computational node. A neural network may operate in a training phase and an inference phase. During training, model parameters may be updated based on a loss function that measures a difference between a predicted output and a reference output. During inference, the neural network may process new input data using trained model parameters.

The term “inference” may be used herein to refer to forward execution of a machine learning model using trained model parameters. Inference may include propagation of input data through successive layers of the machine learning model to generate one or more output values.

The term “state space model” (SSM) may be used herein to refer to a computational model, or a layer of a machine learning model, that represents sequential data using a structured state transition mechanism. The SSM may maintain a fixed-dimension state vector that evolves across discrete time indices according to learned state transition parameters. The state vector may represent prior input samples in a compact form. An SSM layer may be evaluated using a parallel convolutional formulation during training to support batch computation. The same SSM layer may be evaluated using a recurrent formulation during inference to update the state vector sequentially using bounded memory. The parallel convolutional formulation and the recurrent formulation may implement equivalent state transition dynamics.

The term “state vector” may be used herein to refer to a fixed-dimension internal vector maintained by the SSM during sequence processing. The state vector may encode a learned representation of prior input samples given the learned state-transition parameters. The state vector may evolve over successive time indices and support modeling of long-range temporal dependencies without storing a full input sequence.

The term “automatic modulation classification” (AMC) may be used herein to refer to automated identification of a signal modulation structure or radar waveform family based on received baseband samples without prior knowledge of transmitter parameters. In a communication context, AMC may include identification of modulation formats such as amplitude modulation, frequency modulation, phase-shift keying (PSK), frequency-shift keying (FSK), and quadrature amplitude modulation (QAM). In a radar context, AMC may include identification of a radar waveform family or pulse coding structure based on received radar emissions or radar reflections. Radar waveform families may include rectangular pulse trains defined by pulse width and pulse repetition interval (PRI), linear frequency modulation (LFM) waveforms defined by time-varying instantaneous frequency, Barker-coded pulses, Frank-coded pulses, and coherent pulse trains. Unless otherwise specified, AMC may include communication modulation classification and radar waveform family classification.

Some embodiments may include a radar signal processing system that integrates a temporal neural network with an SSM. The radar signal processing system may process sequential in-phase and quadrature baseband samples and perform AMC or radar target detection. The temporal neural network may model temporal dependencies, and the SSM may provide structured state transition dynamics. The integrated architecture may support real-time radar signal processing. In some embodiments, the temporal neural networks may be Temporal Event Neural Networks (TENNs).

A radar system may transmit a radio frequency (RF) signal and receive reflections from one or more targets. The radar system may process the received signal to estimate target range, velocity, and angle. The received signal may include clutter, noise, interference, and multipath effects. Radar performance may depend on extraction of target information under these conditions.

Radar signal processing may include target detection, AMC, and clutter suppression. Target detection may determine presence of a target. AMC may identify a modulation structure or radar waveform family. Clutter suppression may reduce undesired reflections. Conventional radar processing techniques may include matched filtering, Doppler processing, and statistical hypothesis testing. These techniques may degrade in low signal-to-noise-ratio (SNR) conditions, non-stationary clutter, or dynamic interference environments.

Matched filtering may correlate a received signal with a reference waveform to increase SNR. Matched filtering may assume knowledge of the transmitted waveform and stable channel conditions. Doppler processing may apply a Fast Fourier Transform (FFT) across time to estimate velocity from frequency shift. FFT-based processing may assume quasi-stationary behavior within an observation window. Constant False Alarm Rate (CFAR) detection may set detection thresholds based on local noise statistics and assume simplified clutter models. Modern radar environments may include non-stationary clutter, agile targets, and dense interference. These conditions may reduce effectiveness of conventional techniques, and there is a need for machine learning models that process long temporal contexts with reduced memory usage.

Machine learning models may be applied to radar signal processing. A CNN may process a time-frequency representation. An RNN may process sequential data using recurrent state updates. A Transformer model may process long sequences using attention mechanisms. A CNN may use preprocessing to generate a time-frequency representation and not directly model long-range temporal dependencies in raw baseband sequences. An RNN may experience vanishing gradients and sequential training constraints. A Transformer model may incur quadratic computational complexity with respect to sequence length. These characteristics may limit deployment in resource-constrained radar systems.

Some embodiments may be configured to perform radar waveform classification using raw I/Q baseband samples. Radar waveform classification may identify a radar waveform family or pulse coding structure. Radar waveform families may include rectangular pulse waveforms, LFM waveforms, Barker-coded pulses, Frank-coded pulses, and coherent pulse trains. Radar waveform classification may differ from communication modulation classification because radar waveform design may emphasize range resolution, Doppler tolerance, and pulse-compression performance rather than information throughput. A temporal neural network integrated with an SSM may perform radar waveform classification or communication modulation classification depending on the training dataset and operational configuration.

Some embodiments may be configured to perform real-time signal processing and signal enhancement (e.g., speech enhancement). An SSM-based temporal neural network may offer advantages for processing sequential data efficiently in real time compared to conventional deep learning architectures. TENNs use structured temporal kernels, which allow them to capture complex, long-range temporal correlations in data more efficiently and accurately than conventional approaches like standard Temporal Convolutional Networks (TCNs), RNNs, or Transformers. Temporal neural networks with SSM offer significant advantages over traditional DL approaches by efficiently modeling long-range temporal dependencies within the signal. They may achieve this by representing signals using state-space equations, allowing the network to maintain a comprehensive understanding of temporal relationships without the vanishing-gradient problem that typically affects conventional RNNs or LSTMs. As a result, temporal neural networks-based models may not only deliver comparable accuracy in identifying modulation schemes but also offer reduced computational complexity, enabling real-time modulation classification even in resource-constrained environments. An SSM layer may be evaluated using a parallel convolutional formulation during training to support batch computation. The same SSM layer may be evaluated using a recurrent formulation during inference to update the state vector sequentially using bounded memory. This dual-mode execution may allow SSM-based temporal neural networks to leverage GPU parallelism for efficient training while converting to a lightweight recurrent form for low-latency streaming inference on edge devices. TENNs leverage structured SSMs that allow matrix-based updates, enabling efficient parallel computation across long sequences. This architecture eliminates the bottleneck of sequential dependencies, significantly accelerating training and inference, especially for long-range temporal modeling tasks.

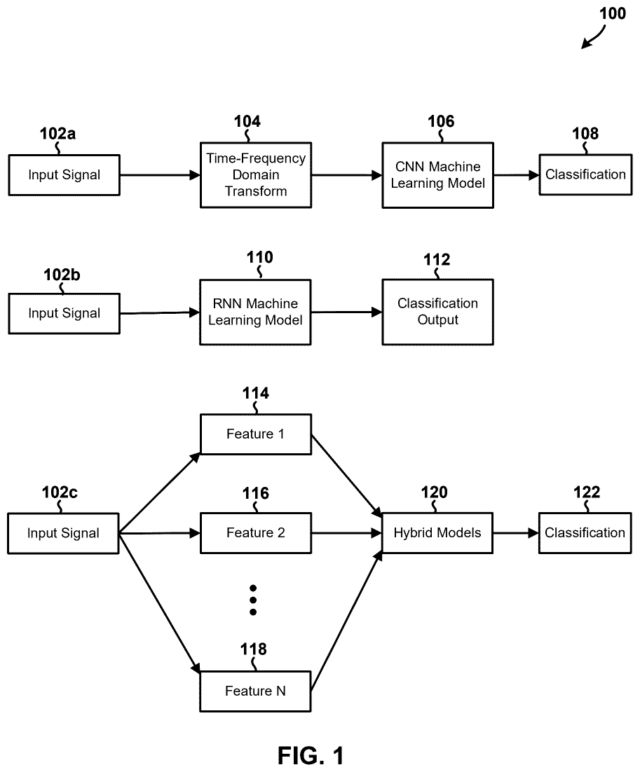

FIG. 1 illustrates a signal processing system 100 configured to perform AMC using multiple processing paths. The signal processing system 100 may include input signals 102a, 102b, and 102c, a time-frequency transform block 104, a CNN machine learning model block 106, a classification block 108, an RNN machine learning model block 110, a classification output block 112, feature extraction blocks 114, 116, and 118, a hybrid model block 120, and a classification block 122.

The signal processing system 100 may receive one or more input signals 102a, 102b, or 102c representing received baseband radar signals. The signal processing system 100 may route the input signal 102a to the time-frequency transform block 104, which may generate a time-frequency representation and provide it to the CNN machine learning model block 106. The CNN machine learning model block 106 may generate classification scores and provide them to the classification block 108. In some embodiments, the input signal 102a may include a time-domain sample sequence representing a received baseband radar signal. In some embodiments, the time-domain sample sequence may include complex baseband samples (e.g., an in-phase component and a quadrature component). In some embodiments, the time-frequency transform block 104 may apply one or more time-frequency transforms to the input signal 102a. In some embodiments, the time-frequency transform block 104 may apply a short-time Fourier transform (STFT), a windowed Fast Fourier Transform (FFT), a wavelet transform, a Wigner-Ville distribution, or similar technique to generate a time-frequency representation that includes, for example, magnitude values, phase values, or complex coefficients. The CNN machine learning model block 106 may receive the time-frequency representation and apply convolution operations across one or more dimensions of the time-frequency representation to generate feature representations or classification scores. The classification block 108 may receive the classification scores and map the classification scores to a classification output. The classification output may include, for example, a class label, a confidence value, or a probability distribution corresponding to candidate classes.

The signal processing system 100 may route the input signal 102b to the RNN machine learning model block 110. The input signal 102b may include a time-domain sample sequence representing received complex baseband radar samples that include in-phase and quadrature components. The RNN machine learning model block 110 may receive the input signal 102b as a sequence of sample vectors, process the sequence across successive sample intervals, and update an internal state vector at each interval. The RNN machine learning model block 110 may generate classification scores corresponding to candidate classes and provide the classification scores to the classification output block 112. The classification output block 112 may map the classification scores to a classification output. The classification output may include, for example, a class label, a confidence value, or a probability distribution corresponding to candidate classes.

The signal processing system 100 may route the input signal 102c to the feature extraction blocks 114, 116, and 118. The input signal 102c may include a time-domain sample sequence representing received complex baseband radar samples that include an in-phase component and a quadrature component. The feature extraction block 114 may generate a first feature vector that includes time-domain descriptors, pulse timing descriptors, autocorrelation descriptors, or statistical descriptors. The feature extraction block 116 may generate a second feature vector that includes, for example, spectral descriptors, cyclostationary descriptors, higher-order statistical descriptors, or time-frequency descriptors. The feature extraction block 118 may generate one or more additional feature vectors representing additional signal characteristics extracted from the input signal 102c. The feature extraction blocks 114, 116, and 118 may provide the feature vectors to the hybrid model block 120. The hybrid model block 120 may combine the feature vectors to generate a fused feature representation and apply one or more machine learning models to the fused feature representation to generate classification scores. The classification block 122 may receive the classification scores and map the classification scores to a classification output. The classification output may include, for example, a class label, a confidence value, or a probability distribution corresponding to candidate classes.

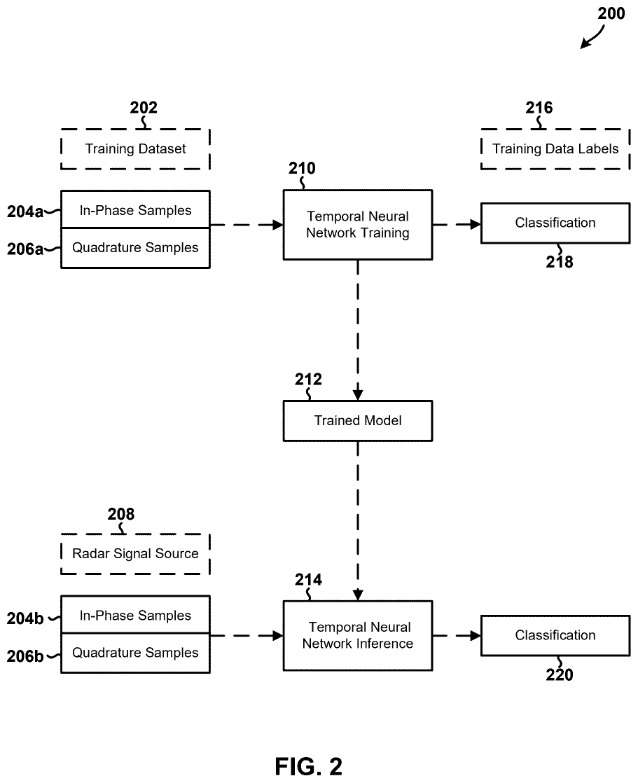

FIG. 2 illustrates a temporal neural network processing system 200 configured to perform AMC using a training workflow and an inference workflow. The temporal neural network processing system 200 may include a training dataset 202, in-phase samples 204a, quadrature samples 206a, a temporal neural network training block 210, training data labels 216, a classification block 218, a trained model 212, a radar signal source 208, in-phase samples 204b, quadrature samples 206b, a temporal neural network inference block 214, and a classification block 220. The trained model 212 may provide a model definition and model parameters to the temporal neural network inference block 214.

During the training workflow, the training dataset 202 may provide training records to the temporal neural network training block 210. Each training record may include a sequence of baseband radar samples and an associated reference class label. The in-phase samples 204a may represent an in-phase component of a complex baseband training sequence, and the quadrature samples 206a may represent a quadrature component of the complex baseband training sequence. The in-phase samples 204a and the quadrature samples 206a may correspond to the same discrete sample indices and be temporally aligned. The training data labels 216 may provide a reference class label corresponding to a selected training record to the classification block 218.

The temporal neural network training block 210 may receive the in-phase samples 204a and the quadrature samples 206a and form complex sample vectors from paired I/Q samples. The temporal neural network training block 210 may process the complex sample vectors using one or more temporal convolution layers and one or more SSM layers. The temporal neural network training block 210 may generate classification scores corresponding to candidate classes and provide the classification scores to the classification block 218. The classification block 218 may receive classification scores and a reference class label, generate a classification output, and compute a training objective using a loss function that measures the difference between the classification output and the reference class label. The classification block 218 may provide the training objective to the temporal neural network training block 210. The temporal neural network training block 210 may update model parameters based on the training objective, and the trained model 212 may store the model definition and the updated model parameters generated during the training workflow.

During the inference workflow, the radar signal source 208 may provide a time-ordered stream of complex baseband radar samples. The in-phase samples 204b may represent an in-phase component of a real-time complex baseband sequence, and the quadrature samples 206b may represent a quadrature component of the real-time complex baseband sequence. The in-phase samples 204b and the quadrature samples 206b may correspond to the same discrete sample indices and be temporally aligned.

The temporal neural network inference block 214 may receive the in-phase samples 204b, the quadrature samples 206b, the model definition, and the model parameters from the trained model 212. The temporal neural network inference block 214 may execute a recurrent processing mode in which one or more temporal convolution layers may be represented as recurrent state updates. The temporal neural network inference block 214 may update a state vector at successive sample indices while processing the I/Q sample sequence. The temporal neural network inference block 214 may generate classification scores corresponding to candidate classes and provide the classification scores to the classification block 220. The classification block 220 may receive the classification scores and map the classification scores to a classification output. The classification output may include a class label and a confidence value corresponding to candidate classes. The temporal neural network inference block 214 may process the sequence using a bounded input buffer for the in-phase samples 204b and the quadrature samples 206b.

In some embodiments, the temporal neural network training block 210 may execute temporal convolution layers and SSM layers using a convolution execution mode during training. The convolution execution mode may evaluate an SSM layer using a convolutional formulation that processes a sequence in parallel across multiple time indices. The temporal neural network inference block 214 may execute the same SSM layer using a recurrent execution mode. In the recurrent execution mode, the SSM layer may update a state vector sequentially for each input sample. The convolution execution mode and the recurrent execution mode may represent equivalent state transition dynamics of the SSM layer. The convolution execution mode may support batch computation during training, and the recurrent execution mode may support streaming execution during inference using bounded memory.

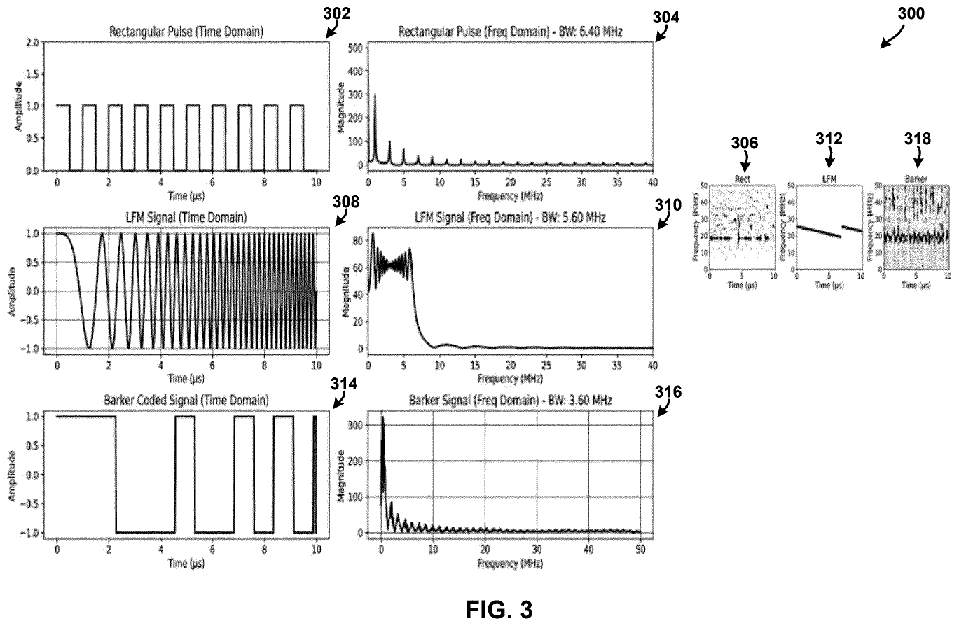

FIG. 3 illustrates a radar waveform representation system 300. The radar waveform representation system 300 may present multiple representations of radar waveforms that may be used for waveform analysis, training dataset generation, or evaluation of a machine learning model configured to perform AMC. The radar waveform representation system 300 may include a rectangular pulse time-domain representation 302, a rectangular pulse frequency-domain representation 304, a rectangular pulse time-frequency representation 306, an LFM time-domain representation 308, an LFM frequency-domain representation 310, an LFM time-frequency representation 312, a Barker-coded waveform time-domain representation 314, a Barker-coded waveform frequency-domain representation 316, and a Barker-coded waveform time-frequency representation 318.

The system may associate each radar waveform with a time-domain representation, a frequency-domain representation, and a time-frequency representation. These representations may describe different signal characteristics that may be used by a machine learning model to distinguish radar waveform families during AMC.

The rectangular pulse time-domain representation 302 may present amplitude values as a function of time for a rectangular pulse waveform. The rectangular pulse waveform may include a sequence of pulses defined by a pulse width parameter and a pulse repetition interval. The rectangular pulse frequency-domain representation 304 may present spectral magnitude as a function of frequency for the rectangular pulse waveform and illustrate a spectral distribution associated with the pulse waveform. The spectral distribution may correspond in part to bandwidth determined by the pulse width parameter. The rectangular pulse time-frequency representation 306 may present frequency as a function of time, with an intensity scale representing spectral energy and/or variations in spectral energy across time for the rectangular pulse waveform.

The LFM time-domain representation 308 may present amplitude values as a function of time for an LFM waveform. The LFM waveform may include a frequency-modulated pulse, in which instantaneous frequency varies linearly with time. The LFM frequency-domain representation 310 may present spectral magnitude as a function of frequency for the LFM waveform and illustrate spectral bandwidth associated with the chirp waveform. The LFM time-frequency representation 312 may present frequency as a function of time with an intensity scale representing spectral energy, and illustrate a sloped ridge pattern corresponding to linear variation of instantaneous frequency over time.

The Barker-coded waveform time-domain representation 314 may present waveform values as a function of time for a phase-coded radar waveform. The Barker-coded waveform may include a sequence of sub-pulses defined by a Barker code sequence. The Barker-coded waveform time-domain representation 314 may illustrate phase transitions associated with the Barker code sequence. The Barker-coded waveform frequency-domain representation 316 may present spectral magnitude as a function of frequency for the Barker-coded waveform and illustrate spectral distribution generated by the coded pulse sequence. The Barker-coded waveform time-frequency representation 318 may present frequency as a function of time with an intensity scale representing spectral energy and illustrate spectral energy distributed across the duration of the coded pulse sequence in a manner that reflects the phase-coded structure of the Barker-coded waveform.

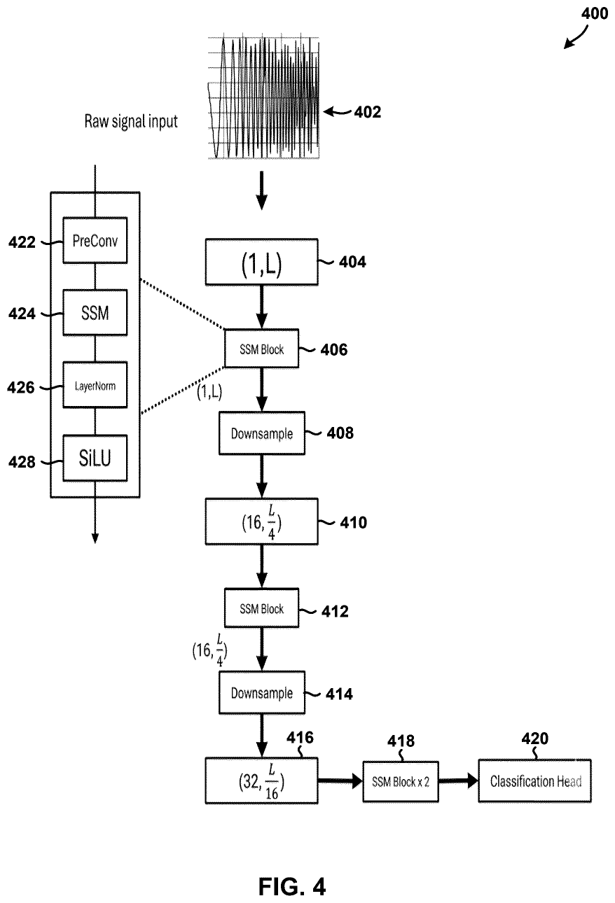

FIG. 4 illustrates an SSM-based encoder system 400 configured to process sequential radar baseband samples and to generate a classification output. The SSM-based encoder system 400 may include a raw signal input 402, an input tensor 404, a first SSM block 406, a first downsample block 408, a first intermediate tensor 410, a second SSM block 412, a second downsample block 414, an encoder output tensor 416, a post-encoder SSM block set 418, a classification head 420, a pre-convolution block 422, an SSM layer 424, a layer normalization block 426, and an activation block 428.

The SSM-based encoder system 400 may receive the raw signal input 402 and may transform the raw signal input 402 into the input tensor 404. The SSM-based encoder system 400 may process the input tensor 404 through the first SSM block 406, the first downsample block 408, the second SSM block 412, the second downsample block 414, and the post-encoder SSM block set 418 to generate the encoder output tensor 416 and a feature tensor. The classification head 420 may receive the feature tensor and may generate the classification output.

The raw signal input 402 may include complex baseband radar samples that include an in-phase (I) component and a quadrature (Q) component. The input tensor 404 may represent the complex baseband radar samples as a tensor that includes a channel dimension and a time dimension. In some embodiments, the input tensor 404 may represent the I component and the Q component as separate channels with dimension (2, L), where L may represent sequence length. In some embodiments, the input tensor 404 may represent the complex baseband radar samples using a real-valued mapping with dimension (1, L). Accordingly, the input tensor 404 may include one or more channels and a time dimension corresponding to sequence length L.

The first SSM block 406 may receive the input tensor 404 and may apply a structured state transition operation across the time dimension to generate an intermediate tensor. The first SSM block 406 may update a state vector at successive time indices and may provide the intermediate tensor to the first downsample block 408. The first SSM block 406 may include the pre-convolution block 422, the SSM layer 424, the layer normalization block 426, and the activation block 428.

An SSM block, such as the first SSM block 406 or the second SSM block 412, may include the pre-convolution block 422, the SSM layer 424, the layer normalization block 426, and the activation block 428. The pre-convolution block 422 may receive a block input tensor and may apply a convolution operation across the time dimension to generate a convolution output tensor. The SSM layer 424 may receive the convolution output tensor and may apply a state transition equation across successive time indices to update a state vector and to generate an SSM output tensor. The layer normalization block 426 may receive the SSM output tensor and may apply a normalization operation across the channel dimension to generate a normalized tensor. The activation block 428 may receive the normalized tensor and may apply an activation function to generate a block output tensor. In some embodiments, the activation function may include a sigmoid-weighted linear unit (SiLU) activation function.

The first downsample block 408 may receive the intermediate tensor generated by the first SSM block 406 and may reduce the time dimension using a resampling factor. The first downsample block 408 may apply a linear projection across the channel dimension. In the example shown in FIG. 4, the first downsample block 408 may generate the first intermediate tensor 410 with dimension (16, L/4). The first intermediate tensor 410 may represent a sequence representation with sixteen channels and a time dimension corresponding to L/4.

Each downsample block may perform temporal resampling and channel projection using a learned linear transformation. A downsample block may group adjacent time indices and may apply a trainable projection tensor to generate a reduced-length sequence. The projection operation may be expressed using tensor contraction operations within a machine learning framework. The learned linear transformation may preserve signal characteristics extracted by the preceding SSM block while reducing sequence length.

The second SSM block 412 may receive the first intermediate tensor 410 and may apply a structured state transition operation across successive time indices. The second SSM block 412 may update a state vector that represents temporal dependencies of the sequence representation and may generate an intermediate tensor for the second downsample block 414. The second downsample block 414 may receive the intermediate tensor generated by the second SSM block 412, may reduce the time dimension using a resampling factor, and may apply a linear projection across the channel dimension. In the example shown in FIG. 4, the second downsample block 414 may generate the encoder output tensor 416 with dimension (32, L/16).

The encoder output tensor 416 may represent a sequence representation with thirty-two channels and a time dimension corresponding to L/16. The post-encoder SSM block set 418 may receive the encoder output tensor 416 and may apply one or more SSM blocks to further process the sequence representation. In the example shown in FIG. 4, the post-encoder SSM block set 418 may include two SSM blocks. The post-encoder SSM block set 418 may generate the feature tensor for the classification head 420.

The classification head 420 may receive the feature tensor from the post-encoder SSM block set 418 and may apply pooling across the time dimension to generate a feature vector. The classification head 420 may generate the classification output. The classification output may include classification scores, a class label, or both, corresponding to candidate classes.

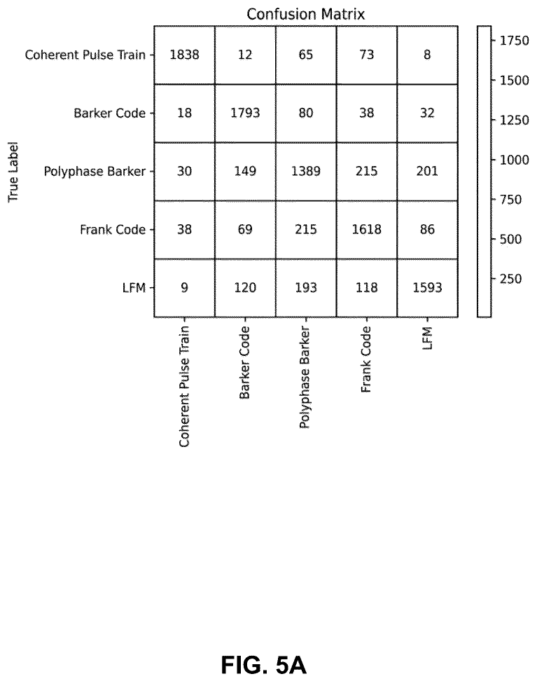

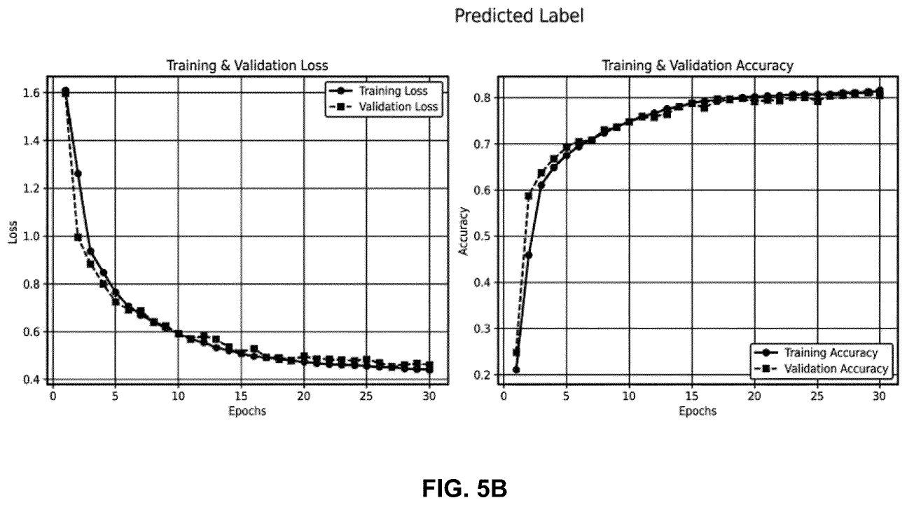

FIG. 5A illustrates an AMC evaluation diagram 500A. The AMC evaluation diagram 500A may include a confusion matrix 502, a true label axis 504, a predicted label axis 506, matrix cells 508, a class set 510, and a cell value scale 512. In the example illustrated in FIG. 5A, AMC may include radar waveform family classification in which the class set corresponds to radar waveform families rather than communication modulation formats.

The AMC evaluation diagram 500A may present the classification performance of a machine learning model configured to perform AMC. The confusion matrix 502 may summarize the relationships between the predicted class labels generated by the machine learning model and the reference class labels provided by an evaluation dataset. The rows of the confusion matrix 502 may correspond to reference class labels listed along the true label axis 504. The columns of the confusion matrix 502 may correspond to predicted class labels listed along the predicted label axis 506.

Each matrix cell 508 may store a count of evaluation records corresponding to a combination of a reference class label and a predicted class label. Matrix cells located along a diagonal of the confusion matrix 502 may represent evaluation records in which the predicted class label corresponds to the reference class label. The class set 510 may include radar waveform families such as rectangular pulse trains, Barker-coded pulses, Frank-coded pulses, and LFM waveforms. Each radar waveform family may correspond to a radar waveform design characterized by temporal structure and spectral characteristics. The confusion matrix 502 may therefore summarize classification performance across radar waveform families. The cell value scale 512 may map a numeric value range associated with the matrix cells 508 to a display intensity. The display intensity may provide a visual representation of classification counts associated with the confusion matrix 502.

FIG. 5B illustrates a training metric diagram 500B. The training metric diagram 500B may include a loss plot 522, a training loss curve 524, a validation loss curve 526, an epoch axis 528, a loss axis 530, an accuracy plot 532, a training accuracy curve 534, a validation accuracy curve 536, an epoch axis 538, and an accuracy axis 540.

The training metric diagram 500B may present training metrics associated with training of a machine learning model configured to perform AMC. The loss plot 522 may present the training loss curve 524 and the validation loss curve 526 as a function of the epoch axis 528, and the loss axis 530 may represent a range of loss values associated with the loss plot 522. The training loss curve 524 may represent a loss value computed for a training dataset at successive training epochs. The validation loss curve 526 may represent a loss value computed for a validation dataset at successive training epochs.

The accuracy plot 532 may present the training accuracy curve 534 and the validation accuracy curve 536 as a function of the epoch axis 538, and the accuracy axis 540 may represent a range of accuracy values associated with the accuracy plot 532. The training accuracy curve 534 may represent an accuracy value computed for the training dataset at successive training epochs. The validation accuracy curve 536 may represent an accuracy value computed for the validation dataset at successive training epochs. The training metric diagram 500B may therefore present comparative training metrics for the training dataset and the validation dataset across successive training epochs.

As mentioned, AMC aims to automatically identify the modulation scheme of a received signal. Modulation may refer to the process of varying one or more properties of a carrier wave (e.g., amplitude, frequency, phase, etc.) to encode information. Different modulation schemes may have distinct characteristics that may be used to convey information efficiently under varying channel conditions and application requirements.

AMC may operate by analyzing incoming signals and determining which modulation type is being used without prior knowledge or explicit cooperation from the transmitter. These operations may be used in various applications, such as cognitive radio systems, where they help with dynamic spectrum access by identifying and adapting to existing modulation schemes in the environment. In electronic warfare, AMC may enable the identification of potential threats by analyzing the modulation of intercepted signals, while in spectrum management, it may help regulators monitor and manage frequency usage effectively.

Traditionally, AMC relied on manually crafted features and statistical approaches. These methods involve extracting certain signal characteristics, such as higher-order statistics, cyclic cumulants, or spectral features, and then using rule-based or machine learning classifiers to identify the modulation. However, such traditional approaches often encounter limitations when operating under real-world conditions, such as multipath fading, interference, low signal-to-noise ratios (SNR), and high computational complexity associated with feature extraction. Moreover, these methods are challenged when encountering modulation schemes that were not previously known or were significantly distorted by environmental factors.

The advent of deep learning (DL) has dramatically advanced AMC performance by shifting away from manual feature engineering towards automated feature learning directly from raw signal data. DL methods, including CNNs, RNNs, and Long Short-Term Memory (LSTM) networks, have demonstrated the ability to capture complex, high-dimensional patterns directly from signals. CNNs, for example, are particularly effective when signals are represented in time-frequency domains, such as spectrograms or Wigner-Ville Distributions (WVD), as they excel in spatial feature extraction. In contrast, RNNs and LSTMs are well-suited for processing sequential signal data, capturing the temporal dependencies of modulation schemes.

More recently, advanced models such as temporal neural networks (e.g., TENNs, etc.) integrated with SSM have been introduced to further improve AMC. Temporal neural networks with SSM offer significant advantages over traditional DL approaches by efficiently modeling long-range temporal dependencies within the signal. They achieve this by representing signals using state-space equations, allowing the network to maintain a comprehensive understanding of temporal relationships without the vanishing-gradient problem that typically affects conventional RNNs or LSTMs. As a result, temporal neural networks-based models not only deliver comparable accuracy in identifying modulation schemes but also offer reduced computational complexity, enabling real-time modulation classification even in resource-constrained environments.

In practice, AMC using temporal neural networks or other deep learning methods begins with the collection of raw radar or communication signals, typically represented as In-phase (I) and Quadrature (Q) samples. These samples contain essential amplitude and phase information necessary for modulation identification. The signal is then either directly processed or transformed into alternative representations, such as constellation diagrams, spectrograms, or time-frequency distributions, depending on the chosen DL architecture. The neural network learns distinguishing features of each modulation type during a supervised training phase, using labeled datasets where the modulation schemes are known in advance. After training, the network may generalize to automatically classify unknown signals, even under challenging conditions such as varying noise levels, multipath interference, or intentional jamming.

Radar target detection is one of the core functions in radar systems, crucial across various applications including defense, aviation, maritime navigation, autonomous driving, and weather monitoring. A primary goal of radar target detection is to determine whether a target exists within the radar's coverage area by analyzing the reflected radar signals. This involves differentiating genuine target echoes from background clutter, noise, and interference, which often poses significant challenges due to the highly dynamic and complex environments where radar systems operate.

Traditional radar target detection methods primarily involve the application of matched filtering, where the received signal is correlated with a known transmitted waveform. This method maximizes the SNR, enhancing the ability to detect weak target signals in noisy environments. However, matched filtering alone is usually insufficient, as real-world scenarios often involve clutter (e.g., unwanted reflections from non-target objects like terrain, sea surfaces, rain, buildings, etc.) that may severely degrade detection performance. To address this issue, statistical methods such as constant false-alarm rate (CFAR) detection have been used. CFAR detectors dynamically adjust detection thresholds based on local estimates of noise and clutter levels, thereby maintaining a relatively constant rate of false alarms despite varying background conditions.

However, these traditional approaches come with limitations. Matched filters assume perfect knowledge of the transmitted waveform and the channel response, which is rarely the case in practice. They also perform poorly when faced with complex modulation schemes, rapidly varying environmental conditions, or unknown targets with dynamic characteristics. Similarly, CFAR methods rely heavily on statistical models of clutter and noise, which are often oversimplified. This may lead to performance degradation in non-stationary clutter environments, like urban settings or sea clutter, where clutter characteristics change rapidly and unpredictably.

The emergence of deep learning (DL) in recent years has offered promising alternatives to conventional radar target detection methods. DL approaches, such as CNNs, have been particularly successful due to their ability to automatically learn complex, high-dimensional features directly from raw radar data. CNNs, often applied to time-frequency representations like spectrograms, may effectively distinguish between target echoes and clutter by capturing subtle spatial patterns and correlations in the radar returns. They provide superior performance over traditional methods in challenging scenarios such as low SNR environments, dense clutter, or targets with complex motion patterns.

Further, hybrid deep learning approaches combining CNNs with other architectures such as RNNs or LSTM networks have been developed to address the temporal aspects of radar detection. These architectures are adept at modeling sequential data, capturing time-dependent variations in radar signals to differentiate moving targets from stationary clutter or noise.

More recently, advanced architectures like temporal neural networks integrated with SSM have further advanced radar target detection. temporal neural networks with SSM efficiently model long-range temporal dependencies within radar data, making them highly suitable for detecting targets in cluttered, non-stationary environments. Unlike traditional DL methods, which may struggle with modeling extended time-series correlations, temporal neural networks maintain a state-based representation of radar signals, allowing them to effectively capture and predict target behaviors even under highly dynamic conditions. This approach also reduces computational complexity, enabling real-time detection performance for applications like autonomous vehicles, air traffic control, and military surveillance systems.

In practice, radar target detection using these advanced methods typically begins with the collection of raw radar signals, represented in terms of In-phase (I) and Quadrature (Q) baseband samples. These signals contain information about the amplitude, phase, and Doppler characteristics of reflected signals. Depending on the architecture, these raw signals may be directly fed into deep neural networks or transformed into time-frequency representations such as spectrograms, CNNs, or other similar formats suitable for CNN processing. During the training phase, networks are trained on large datasets containing labeled examples of target and non-target signals across various conditions. Once trained, these networks may generalize effectively, accurately detecting targets even under highly variable and noisy conditions.

CNNs are a specialized type of artificial neural network primarily designed to analyze and interpret visual information, such as images and videos. CNNs have driven breakthroughs in computer vision applications, including image classification, object detection, facial recognition, autonomous driving, and medical imaging. Beyond vision, CNNs have also been adapted successfully to process other types of structured data like time-series signals and audio recordings.

CNNs implement an operation called convolution—the process from which these networks derive their name. Convolution involves applying a small, learnable filter (often referred to as a kernel) across the entire input data. This filter moves systematically, step-by-step, from one position to the next over the input, similar to how a flashlight would scan over an image to highlight particular features. At each step, the filter multiplies the values of the input data beneath it by its own learned weights and then sums up these values to produce a single number. This number represents how closely the local section of the input data matches the particular feature or pattern the filter is trained to detect.

For example, in the early layers of a CNN analyzing an image, these filters might learn simple patterns such as edges, curves, and textures. As the data passes through deeper layers, the network combines these basic features into increasingly complex representations, eventually identifying high-level structures such as faces, objects, or even scenes. This hierarchical approach enables CNNs to automatically learn and recognize intricate patterns without requiring explicit feature engineering.

A typical CNN architecture includes convolutional layers, where the filters are applied. Each convolutional layer may include one or more filters, each filter may be specialized to detect a specific kind of feature. After the convolutional operation, CNNs typically apply an activation function, such as the Rectified Linear Unit (ReLU). Activation functions introduce nonlinearity into the network, allowing it to learn complex relationships. The ReLU function, for example, replaces all negative values with zero, preserving only the positive responses from the convolution. This nonlinearity enables CNNs to model more sophisticated patterns than would be possible with purely linear transformations.

In addition to convolutional layers, CNNs may include pooling layers. Pooling layers are used to reduce the spatial size of the feature maps produced by convolutions, which helps reduce the number of parameters, computation required and also help control overfitting. One common pooling method is max pooling, which selects the maximum value from a defined window within the feature map and discards the rest. This pooling method may reduce the size of the data and also retain the most prominent features. Pooling makes the CNN more robust by focusing on the most important information and discarding irrelevant details.

After several layers of convolution, activation, and pooling, CNNs usually flatten the processed feature maps into a single vector. This flattened data is then passed into fully connected layers, which are similar to layers in traditional neural networks. Fully connected layers take these high-level features from the previous layers and use them to make final predictions or classifications. For example, in an image classification task, the fully connected layers would determine whether the image belongs to a particular category, such as “cat,” “dog,” or “car.”

CNNs have gained enormous popularity due to their ability to automatically and effectively extract features from raw data, eliminating the need for manual feature engineering that was previously required in many tasks. CNNs may handle spatially structured data where the relationships between data points (e.g., pixels in an image, time steps in a sequence, etc.) may provide information for understanding the overall context.

RNNs are a specialized type of artificial neural network that may process sequential data, which includes data types where the order of information provides information for understanding overall context, such as language, audio signals, or time-series data. Unlike traditional feedforward neural networks, which treat each input independently and without any memory of past inputs, RNNs have an internal memory or “hidden state” that allows them to carry forward information from previous steps in the sequence to influence the processing of current and future inputs.

This memory capability makes RNNs powerful for tasks that involve understanding context, such as language translation, speech recognition, and text generation. In these applications, the meaning of words or signals often depends heavily on what comes before and after them. By maintaining a hidden state, an RNN may capture and utilize these contextual dependencies over time, allowing it to make more accurate predictions or generate coherent outputs based on patterns learned from sequential data.

RNNs process input sequences one step at a time. At each time step, the network takes the current input along with information stored in its hidden state (which represents the context from previous steps) to produce an output and update its hidden state. This updated hidden state is then carried forward to the next time step, ensuring that the network retains and integrates information across the entire sequence. This recurrent connection—where outputs from one step are fed back into the network as input for the next step—is what gives RNNs their name.

Standard RNNs may face significant challenges when dealing with long sequences. Standard RNNs often struggle with what is known as the “vanishing gradient” problem. During training, RNNs use a method called backpropagation through time (BPTT), which involves propagating errors backward through many time steps. However, as errors are propagated further and further back in time, their magnitude often diminishes, eventually becoming too small to influence the learning of early layers effectively. As a result, RNNs may fail to capture long-range dependencies and lose important contextual information, causing them to perform poorly on tasks that require understanding relationships across extended time periods.

To overcome the limitations of standard RNNs, a more advanced type of recurrent network called long short-term memory (LSTM) networks may be used. LSTMs address the problem of capturing long-range temporal dependencies in sequential data, making them variations of standard RNNs.

LSTMs have a specialized internal structure, which allows them to retain important information over long periods while effectively discarding irrelevant details. Unlike standard RNNs, which have a simple hidden state that updates uniformly at each time step, LSTMs introduce a more complex memory mechanism involving “gates.” These gates control the flow of information into and out of the network's internal memory, deciding which information to remember, forget, or update at each step. This selective memory mechanism enables LSTMs to maintain critical context over extended sequences, addressing the vanishing gradient problem that standard RNNs face.

An LSTM consists of several interacting components, each playing a specific role in managing information flow. The key components include the “input gate,” the “forget gate,” and the “output gate.” The input gate determines what new information from the current input should be added to the cell's memory. The forget gate decides which information from the previous memory should be retained or discarded, allowing the network to remove outdated or irrelevant information. The output gate controls what part of the cell's memory should be passed on as output at each time step, influencing the information carried forward in the hidden state.

By using this gating mechanism, LSTMs may effectively preserve important contextual information from much earlier steps in the sequence. This allows them to understand and capture long-term dependencies and patterns that standard RNNs may overlook or forget. LSTMs may have success in a wide range of applications involving complex sequential data, including language modeling, machine translation, speech recognition, and even financial time-series prediction.

In language modeling and machine translation, for example, LSTMs excel at capturing complex grammatical structures and maintaining coherence across long sentences or paragraphs. In speech recognition, they may accurately process entire utterances, recognizing patterns that span multiple words or phrases. Their ability to model these extended relationships and dependencies has made LSTMs useful in natural language processing (NLP) and many other domains involving sequential data.

SSMs are powerful mathematical frameworks used extensively in control theory, signal processing, econometrics, robotics, and more recently in machine learning. They provide a systematic approach for modeling dynamic systems-systems that evolve over time- and are particularly effective for analyzing and predicting behaviors in sequential or time-series data.

At the core of a SSM is the concept of a state vector, which represents all the necessary information about a system at a given time. This state vector captures the internal, often unobserved characteristics of the system, which dictate how it evolves. By describing the system in terms of these hidden states, SSMs allow for a compact yet comprehensive representation of complex dynamics, facilitating prediction, filtering, smoothing, and control tasks.

An SSM typically includes two fundamental equations: the state equation (also called the state transition equation) and the observation equation. The state equation describes how the internal state of the system changes over time, given its previous state and any external inputs or influences. Meanwhile, the observation equation links these internal states to observable outputs, measurements, or data points. Together, these two equations form a description of the system's behavior, allowing for a deep understanding and prediction of its dynamics.

To understand SSMs in more detail, consider the mathematical representation of a discrete-time, linear SSM, which is widely used for its simplicity and effectiveness. The state equation for a discrete-time system is typically written as: xₖ₊₁=Axₖ+Buₖ+wₖ.

In this equation, xₖ represents the state vector at time step k. It contains all the relevant information describing the system at that moment. The state transition matrix A defines how the current state influences the next state. The input matrix B captures how external inputs uk, such as control actions or external disturbances, influence the state transition. Finally, wₖ is the process noise vector, representing uncertainties or random disturbances that affect the system's evolution but are not directly observed or measured. This process noise is typically assumed to be Gaussian with zero mean and some known covariance, representing the inherent unpredictability in many real-world systems.

The observation equation, on the other hand, describes how these internal states translate into measurable outputs. It is commonly represented as: yₖ=Cxₖ+Duₖ+vₖ. Here, yₖ is the observed output or measurement vector at time k. The observation matrix C maps the internal states to these observable outputs, while the feedthrough (direct transmission) matrix D directly relates inputs uₖ to the observed outputs without involving the internal state. The term vₖ represents measurement noise or uncertainty in the observations. Like process noise, it is typically modeled as Gaussian with zero mean, reflecting the fact that real-world measurements often contain errors or noise from various sources such as sensors or environmental conditions.

The embodiments may include practical radar-processing methods that turns raw sensor data into faster and more efficient operational output. The embodiments may provide a processing system with a direct path from raw radio returns to a usable answer about a signal or target. The system may read native in-phase and quadrature (I/Q) data through a time-aware model and skip heavy image-style conversion. The embodiments may cut delay and power draw and keep decisions close to real time.

The radar-processing method may take direct I/Q input into a state-space temporal network with learned downsampling and a shared latent representation. Known radar pipelines often rely on handcrafted transforms or attention-heavy models and place classification after that transform stage. The embodiments may shift the order of operations and link the learned downsampling to the state-space temporal network inside one radar path. The same radar path may support waveform classification, signal detection, and target identification with a lower preprocessing burden and a different hardware profile.

The embodiments may improve the performance and functionality of the system by moving radar analysis from a large preprocessing stack into a compact sequence-processing path. The processing system may read raw I/Q data and reduce sequence length through learned downsampling while preserving task-relevant temporal structure. The embodiments may lower memory movement across processor resources and trim buffer depth in streaming use. The embodiments may allow for aster radar decisions with lower energy draw and a broader fit for edge devices, vehicle platforms, and networked sensing nodes.

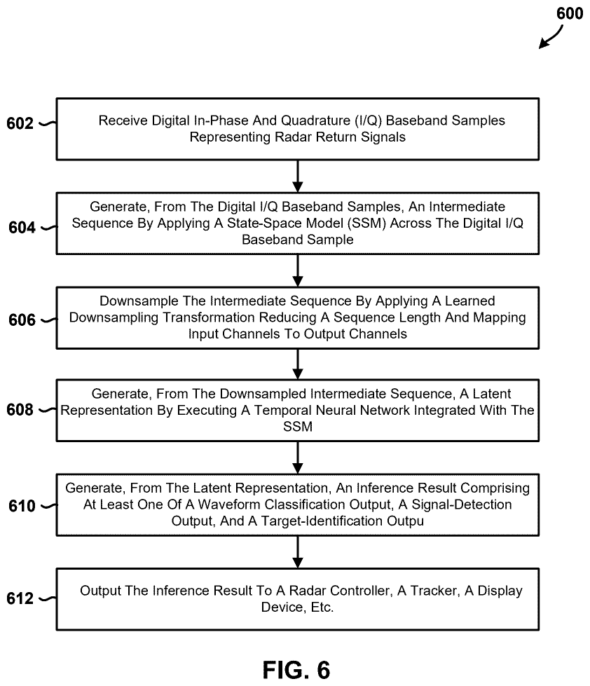

FIG. 6 is a process flow diagram illustrating a method 600 for processing radar signals in accordance with some embodiments. Method 600 may be performed by a processing system in a computing device that includes one or more processors, one or more memories, and one or more interfaces coupled to a radar receiver or another radar signal source. In some embodiments, the processing system may be configured to partition execution of the SSM, the temporal neural network (e.g., TENNs, etc.) integrated with the SSM, and the learned downsampling transformation across the central processing unit, the digital signal processor, the graphics processing unit, the neural processing unit, the field-programmable gate array, or the application-specific integrated circuit according to a selected hardware allocation. In some embodiments, the processing system may be configured to execute front-end sample handling and timing alignment on the digital signal processor, execute at least part of the SSM and the learned downsampling transformation on the neural processing unit or the graphics processing unit, and execute control logic and output formatting on the central processing unit. In some embodiments, the processing system may be configured to optimize execution of the SSM, the temporal neural network, and the learned downsampling transformation by quantizing parameters of the SSM, the temporal neural network, or the learned downsampling transformation, pruning parameters of the SSM, the temporal neural network, or the learned downsampling transformation, and fusing operations of the SSM, the temporal neural network, or the learned downsampling transformation. In some embodiments, the processing system may be configured to convert floating-point weights into fixed-point weights, remove channels or states that satisfy a pruning criterion, and merge a linear projection with a normalization or activation operation so that memory traffic and instruction count decrease during runtime execution.

In block 602 the processing system may receive digital in-phase and quadrature (I/Q) baseband samples representing radar return signals. In some embodiments, the processing system may be configured to receive the digital I/Q baseband samples from a radar receiver front end that downconverts radio-frequency radar returns to baseband and digitizes the baseband with one or more analog-to-digital converters, after which a direct memory access engine transfers the digital I/Q baseband samples into a memory buffer accessible to the processing system. In some embodiments, the processing system may be configured to organize the digital I/Q baseband samples into a pulse sequence, a chirp sequence, a burst, a frame, a dwell, or a range-gated segment before generating the intermediate sequence. In some embodiments, the processing system may be configured to group the digital I/Q baseband samples according to a pulse repetition interval, a chirp boundary, a frame marker, a dwell identifier, or a range-bin index stored in accompanying metadata so that later temporal processing operates on a defined unit of analysis. In some embodiments, the processing system may be configured to condition the digital I/Q baseband samples by normalizing amplitude, removing DC offset, correcting I/Q imbalance, and aligning sample timing before generating the intermediate sequence.

In some embodiments, the processing system may be configured to scale the digital I/Q baseband samples with a gain factor derived from receiver statistics, subtract a running mean from the I channel and the Q channel, correct amplitude mismatch or phase skew between the I channel and the Q channel with a calibration matrix, and align sample timing with a synchronization sequence, a pulse trigger, or a clock reference. In some embodiments, the processing system may be configured to estimate, from the digital I/Q baseband samples, an operating context comprising at least one of a signal-to-noise ratio, a clutter level, an interference level, a compute budget, and a latency budget, and to select, from the operating context, a runtime profile controlling at least one of a sequence length, an enabled task head, a threshold, and a hardware allocation. In some embodiments, the processing system may be configured to estimate the signal-to-noise ratio from noise-only range cells or guard intervals, estimate the clutter level from a background return distribution, estimate the interference level from spectral peaks or impulsive events, read the compute budget and the latency budget from a scheduler or a power manager, and select the runtime profile that determines how many samples enter the SSM, which task heads execute in block 610, which thresholds apply to the inference result, and which processor resources execute the SSM, the temporal neural network, and the learned downsampling transformation.

In some embodiments, the processing system may be configured to omit generation of a Wigner-Ville distribution, a spectrogram, and an image-domain representation from the digital I/Q baseband samples before generating the intermediate sequence. In some embodiments, the processing system may be configured to preserve amplitude and phase information in the digital I/Q baseband samples by processing the digital I/Q baseband samples in native sample form rather than converting the digital I/Q baseband samples into an image-domain representation before temporal modeling.

In block 604 the processing system may generate, from the digital I/Q baseband samples, an intermediate sequence by applying a SSM across the digital I/Q baseband samples. In some embodiments, the processing system may be configured to treat each I/Q sample pair or each short patch of consecutive I/Q sample pairs as an input vector and update an SSM hidden state according to a learned state transition relation and generate an output sequence element according to xₖ₊₁=Axₖ+Buₖ+wₖ and yₖ=Cxₖ+Duₖ+vₖ, in which A, B, C, and D are learned matrices, structured parameterizations, or discretized continuous-time parameters stored in memory. In some embodiments, the processing system may be configured to generate the intermediate sequence as a sequence tensor that has a temporal dimension and a channel dimension, in which the channel dimension stores learned temporal features derived from the digital I/Q baseband samples.

In some embodiments, the processing system may be configured to maintain an SSM hidden state across successive sample windows and to reset the SSM hidden state in response to detecting a mode change, a data discontinuity, or a scan boundary. In some embodiments, the processing system may be configured to retain the SSM hidden state for adjacent windows that belong to a continuous dwell and to clear or reinitialize the SSM hidden state when metadata indicates a beam transition, a waveform change, a dropped-data event, or a scan reset. In some embodiments, the processing system may be configured to capture temporal dependencies that extend across multiple pulses, chirps, or sample windows by updating the SSM hidden state while the temporal index advances and the hidden-state dimension remains fixed. In some embodiments, the processing system may be configured to execute the SSM in a recurrent form that updates the SSM hidden state one index at a time or in a parallel form that computes the intermediate sequence over a block of indices with one or more batched linear algebra operations according to the runtime profile selected in block 602.

In block 606 the processing system may downsample the intermediate sequence by applying a learned downsampling transformation reducing a sequence length and mapping input channels to output channels. In some embodiments, the processing system may be configured to form the learned downsampling transformation as a trainable projection matrix applied to the intermediate sequence to reduce the sequence length by a resampling factor and to map the input channels to the output channels. In some embodiments, the processing system may be configured to transform an input tensor into an output tensor. In some embodiments, the processing system may be configured to apply the trainable projection matrix as a tensor-contraction operation defined by an Einstein-summation expression.

In some embodiments, the processing system may be configured to evaluate the tensor-contraction operation using an Einstein-summation expression that contracts the temporal grouping dimension and the channel dimension of the intermediate sequence with the learned coefficients of the trainable projection matrix, so that adjacent temporal elements contribute to each output element. In some embodiments, the processing system may be configured to reduce sequence length before later neural processing so that buffer depth, memory traffic, and arithmetic count decrease while task-relevant temporal and spectral structure remains represented in the output channels. In some embodiments, the processing system may be configured to select the resampling factor from a fixed value, a runtime-selected value, or a value associated with a radar mode, an available memory budget, an available latency budget, or the operating context estimated in block 602.

In block 608 the processing system may generate, from the downsampled intermediate sequence, a latent representation (e.g., a compressed encoding of the digital I/Q baseband samples in a reduced-dimension feature space) by executing a temporal neural network integrated with the SSM. In some embodiments, the processing system may be configured to execute one or more temporal neural network blocks that each include an SSM-derived temporal operator, one or more learned linear projections, one or more nonlinear activation functions, one or more normalization layers, and one or more residual connections, with the one or more temporal neural network blocks receiving the downsampled intermediate sequence and producing a higher-level sequence representation. In some embodiments, the processing system may be configured to integrate the SSM with the temporal neural network by using the SSM as a temporal mixing operator within each temporal neural network block, by stacking SSM layers with feedforward layers, or by coupling an SSM encoder to a temporal backbone that refines the sequence representation.

In some embodiments, the processing system may be configured to generate the latent representation as a pooled sequence vector, a final hidden state, a set of token embeddings, or a compact latent tensor that summarizes modulation structure, temporal correlation, Doppler variation, micro-motion signatures, clutter characteristics, or interference patterns present in the downsampled intermediate sequence. In some embodiments, the processing system may be configured to compress high-dimensional sequence data into the latent representation so that later output heads operate on a compact feature space rather than on the full-resolution temporal input.

In some embodiments, the latent representation may be generated to capture one or more features of the digital I/Q baseband samples including: amplitude patterns, phase trajectories, Doppler behavior, temporal correlations, pulse structures, modulation characteristics, and/or micro-motion signatures. The latent representation may be generated to obtain information to perform automatic modulation classification, waveform classification, target identification, and/or anomaly detection.

In some embodiments, the processing system may be configured to reconstruct, from the latent representation, a reconstructed signal with an encoder-decoder architecture comprising the SSM. In some embodiments, the processing system may be configured to pass the latent representation through a decoder that applies one or more inverse projections, one or more SSM-based temporal expansion layers, or one or more learned upsampling layers to produce the reconstructed signal in a sample domain aligned with the digital I/Q baseband samples. In some embodiments, the processing system may be configured to compare the reconstructed signal with the digital I/Q baseband samples and to generate, from the comparing, an anomaly-detection output. In some embodiments, the processing system may be configured to compute a reconstruction-error metric, a residual-energy metric, or a similarity score between the reconstructed signal and the digital I/Q baseband samples and derive the anomaly-detection output when the comparison indicates a deviation from a nominal signal pattern.

In block 610 the processing system may generate, from the latent representation, an inference result comprising at least one of a waveform classification output, a signal-detection output, and a target-identification output. In some embodiments, the processing system may be configured to generate the waveform classification output by applying a classifier head to the latent representation. In some embodiments, the processing system may be configured to apply a linear layer, a multilayer perceptron, or another classification head to the latent representation and produce class scores over candidate waveform classes or modulation classes. In some embodiments, the processing system may be configured to generate the signal-detection output by applying a detection head to the latent representation. In some embodiments, the processing system may be configured to apply a binary classifier, a score-regression head, or a thresholded detection head to the latent representation and produce a target-present indicator, a signal-present indicator, or a detection score.

In some embodiments, the processing system may be configured to generate the target-identification output by applying a target-classification head to the latent representation representing temporal structure associated with micro-Doppler or target motion. In some embodiments, the processing system may be configured to apply a target-classification head that receives the latent representation and distinguishes among target categories by using temporal features associated with blade motion, wheel motion, body motion, or other target-motion signatures represented in the latent representation.

In some embodiments, the processing system may be configured to generate, from the latent representation, a parameter-estimation output comprising at least one of a pulse-width estimate, a pulse-repetition-interval estimate, a Doppler-related estimate, and a signal-quality estimate. In some embodiments, the processing system may be configured to apply one or more regression heads to the latent representation and output numeric estimates or discretized parameter bins associated with pulse timing, Doppler behavior, or signal quality. In some embodiments, the processing system may be configured to generate, from the latent representation, a confidence output and to suppress the inference result when the confidence output fails to satisfy a threshold. In some embodiments, the processing system may be configured to derive the confidence output from a maximum class score, a calibrated probability, an entropy measure, a margin value, or a detection statistic and withhold a label, downgrade a decision, or request additional samples when the confidence output fails to satisfy the threshold. In some embodiments, the processing system may be configured to combine one or more of the waveform classification output, the signal-detection output, the target-identification output, the parameter-estimation output, the anomaly-detection output, and the confidence output into the inference result so that a downstream subsystem receives a decision-level output rather than full-resolution sensor data.

In block 612 the processing system may output the inference result to at least one of a radar controller, a tracker, and a display device. In some embodiments, the processing system may be configured to write the inference result into a shared memory region, a message queue, a peripheral bus transaction, a network packet, a controller register set, or an application programming interface output object that another subsystem reads for control, tracking, or display. In some embodiments, the processing system may be configured to format the inference result as a structured output record that includes a waveform class identifier, a target-present flag, a target class identifier, a confidence value, an anomaly indicator, a parameter estimate, a time stamp, a beam identifier, a range-bin identifier, a dwell identifier, or a track association identifier.

In some embodiments, the processing system may be configured to perform an adaptation, from the inference result, a radar operation comprising at least one of a threshold setting, a dwell allocation, a waveform schedule, and a resource priority. In some embodiments, the processing system may be configured to raise or lower a detection threshold, extend or shorten a dwell, select a later waveform from a waveform library, or reassign processor time and memory bandwidth according to the inference result. In some embodiments, the processing system may be configured to output the inference result to the radar controller so that the radar controller updates a sensing mode or a scheduling decision, to output the inference result to the tracker so that the tracker initializes, updates, confirms, or suppresses a target track, and to output the inference result to the display device so that the display device renders a label, an alert, a confidence value, or a target icon associated with the radar return signals.

In some embodiments, the processing system may be configured to repeat blocks 602 through 612 for successive windows of digital I/Q baseband samples so that method 600 operates in a streaming mode, a batch mode, or a mixed streaming and batch mode according to the runtime profile selected in block 602.

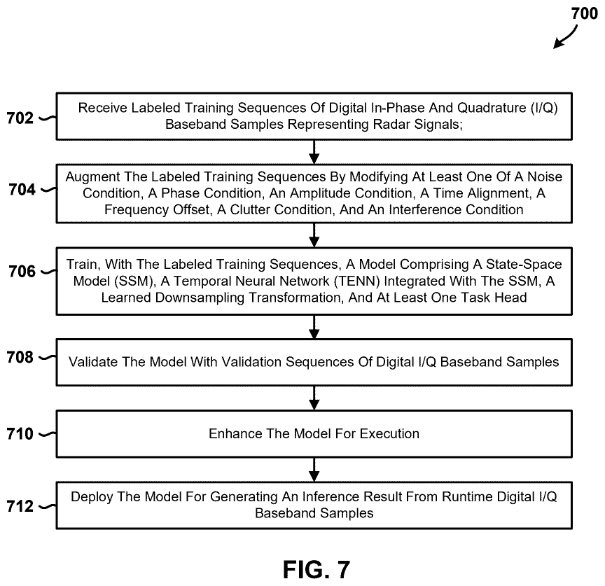

FIG. 7 is a process flow diagram illustrating a method 700 for training and deploying a radar signal processing model in accordance with some embodiments. Method 700 may be performed by a processing system in a computing device that includes one or more processors, one or more memories, one or more storage devices, and one or more interfaces coupled to a training data source or a model deployment target. In some embodiments, the processing system may be configured to load a model definition, training hyperparameters, label maps, augmentation policies, validation criteria, deployment targets, and one or more optimizer states from a non-transitory computer-readable medium before processing training data. In some embodiments, the processing system may be configured to perform method 700 as a sequence of data ingestion, data augmentation, model training, model validation, model optimization, model deployment, runtime logging, and retraining operations that execute in series, in parallel, or in an interleaved training pipeline

In block 702, the processing system may receive labeled training sequences of digital in-phase and quadrature (I/Q) baseband samples representing radar signals. In some embodiments, the processing system may be configured to read the labeled training sequences from, for example, a local dataset repository, a network-attached storage device, a cloud object store, a radar recording system, or a synthetic data generator, parse the labeled training sequences into tensors stored in memory, and associate each tensor with one or more labels stored in a metadata table or a structured training record. In some embodiments, the processing system may be configured to receive the labeled training sequences as windows, pulses, chirps, bursts, frames, dwells, range-gated segments, or channelized sample groups, with each labeled training sequence represented as paired I samples and Q samples or as a two-channel tensor. In some embodiments, the processing system may be configured to receive labels that identify a waveform class, a modulation type, a target-present indication, a target class, an anomaly class, a jamming condition, a pulse-width value, a pulse repetition interval, a Doppler-related value, a signal quality indicator, or a radar mode.

In some embodiments, the processing system may be configured to receive, with the labeled training sequences, metadata that identifies a sampling rate, a center frequency, a bandwidth, a beam identifier, an antenna channel, a capture time, a platform state, a signal-to-noise ratio estimate, a clutter condition, an interference condition, a multipath condition, or a capture source. In some embodiments, the processing system may be configured to generate synthetic training sequences representing radar waveforms or target returns before training the model. In some embodiments, the processing system may be configured to generate a synthetic training sequence by simulating one or more pulse trains, one or more chirp returns, one or more coded radar waveforms, one or more target echoes, one or more micro-Doppler signatures, or one or more clutter returns with a waveform generator, a channel model, or a radar scene simulator, and store the synthetic training sequence with one or more labels and one or more metadata values in the same training format used for measured training sequences. In some embodiments, the processing system may be configured to combine the synthetic training sequences with measured training sequences before training the model so that the training data covers radar conditions, target classes, and waveform classes that measured captures may underrepresent. In some embodiments, the processing system may be configured to organize the labeled training sequences into one or more training batches so that supervised learning and multi-task learning operate on a consistent input format across multiple radar operating conditions.

In block 704, the processing system may augment the labeled training sequences by modifying at least one of a noise condition, a phase condition, an amplitude condition, a time alignment, a frequency offset, a clutter condition, or an interference condition. In some embodiments, the processing system may be configured to add noise to a labeled training sequence by sampling one or more random noise vectors and combining the one or more random noise vectors with the labeled training sequence at a selected signal-to-noise ratio, rotate phase by multiplying the labeled training sequence by a complex exponential, scale amplitude by multiplying the labeled training sequence by a selected gain value, shift time alignment by inserting a delay or by circularly shifting samples, and apply a frequency offset by multiplying the labeled training sequence by a time-varying complex sinusoid.

In some embodiments, the processing system may be configured to augment a clutter condition by mixing land clutter, sea clutter, weather clutter, or synthetic clutter returns into the labeled training sequence and to augment an interference condition by mixing jamming signals, co-channel emitters, impulsive interferers, or multipath replicas into the labeled training sequence. In some embodiments, the processing system may be configured to preserve an original label for an augmentation that does not change class identity and to update or append metadata when an augmentation changes a target parameter, a difficulty level, or a signal condition that later validation tracks separately. In some embodiments, the processing system may be configured to apply augmentation policies deterministically, randomly, or according to a curriculum schedule that changes across epochs. In some embodiments, the processing system may be configured to broaden the set of signal conditions seen during training so that the model later generalizes across noise, clutter, phase variation, amplitude variation, time shift, frequency offset, interference, and multipath that differ from a source dataset.

In block 706, the processing system may train, with the labeled training sequences, a model that includes an SSM, a temporal neural network integrated with the SSM, a learned downsampling transformation, and at least one task head. In some embodiments, the processing system may be configured to execute a forward pass in which a labeled training sequence of digital I/Q baseband samples enters an input stage, an SSM applies temporal state updates to generate an intermediate sequence, a learned downsampling transformation reduces sequence length and maps input channels to output channels, a temporal neural network integrated with the SSM generates a latent representation, and the at least one task head generates one or more predicted outputs for comparison with one or more ground-truth labels. In some embodiments, the processing system may be configured to train the at least one task head to generate at least one of a waveform classification output, a signal-detection output, a target-identification output, an anomaly-detection output, and a parameter-estimation output.

In some embodiments, the processing system may be configured to connect a classification head, a detection head, a target-identification head, an anomaly-detection head, and a regression head to a shared latent representation and compute one or more task-specific losses against one or more corresponding labels so that gradients from multiple tasks update shared backbone parameters and one or more task-head parameters during backpropagation. In some embodiments, the processing system may be configured to train an encoder and a decoder of an SSM-based autoencoder to reconstruct or denoise an input sequence represented by the digital I/Q baseband samples. In some embodiments, the processing system may be configured to route the digital I/Q baseband samples through an SSM-based encoder that generates a compact latent state and through a decoder that reconstructs a clean sequence, and compute a reconstruction loss or a denoising loss between a decoder output and a target sequence while jointly optimizing one or more task-head losses.

In some embodiments, the processing system may be configured to parameterize the SSM with one or more learned matrices, one or more structured kernels, one or more discretized continuous-time parameters, or one or more recurrent state-update operators stored in memory and updated during training. In some embodiments, the processing system may be configured to implement the learned downsampling transformation as a trainable projection matrix, a tensor contraction, an Einstein-summation operation, or another learned resampling operator that reduces temporal resolution while preserving task-relevant structure in the feature channels. In some embodiments, the processing system may be configured to compute one or more loss values that include a classification loss, a detection loss, a regression loss, a reconstruction loss, a denoising loss, a confidence calibration loss, or a weighted combination of multiple losses and to update model parameters with backpropagation and an optimizer that includes stochastic gradient descent, Adam, AdamW, RMSProp, or another gradient-based optimization procedure.

In some embodiments, the processing system may be configured to train the model in single-task form, multi-task form, supervised form, semi-supervised form, curriculum form, or transfer-learning form depending on an available dataset and a selected deployment objective. In some embodiments, the processing system may be configured to capture long-range temporal structure from the digital I/Q baseband samples while reducing sequence length before later neural processing so that the model learns from temporally extended radar behavior without carrying the full cost of full-resolution sequence processing across every layer. In some embodiments, the processing system may be configured to train with mini-batches stored in accelerator memory, to accumulate gradients across multiple mini-batches when an available memory budget limits batch size, and to reset one or more hidden states between unrelated sequences while optionally preserving one or more hidden states within a continuous training window.

In block 708, the processing system may validate the model with validation sequences of digital I/Q baseband samples. In some embodiments, the processing system may be configured to disable parameter updates, process one or more held-out validation sequences through the model, and compare one or more predicted outputs with one or more reference labels to compute one or more validation metrics. In some embodiments, the processing system may be configured to compute one or more validation metrics that include a classification accuracy, a confusion matrix, a precision value, a recall value, an F1 score, a receiver operating characteristic curve, an area under curve value, a probability of detection, a false alarm rate, a regression error, an anomaly detection rate, a latency measure, a memory use measure, or an energy-per-inference estimate. In some embodiments, the processing system may be configured to validate the model across multiple signal-to-noise ratios, clutter conditions, multipath conditions, or jamming conditions before deploying the model. In some embodiments, the processing system may be configured to partition the held-out validation sequences into subsets associated with different signal-to-noise ratio ranges, different clutter regimes, different multipath severities, and different jamming conditions and compute one or more validation metrics separately for the different subsets so that validation characterizes model behavior under distinct operating conditions.

In some embodiments, the processing system may be configured to stratify validation by waveform class, radar mode, target class, beam identifier, or capture source so that validation reveals behavior across different operational regimes. In some embodiments, the processing system may be configured to compare a current validation result with one or more earlier validation results to select an epoch, to trigger early stopping, to tune one or more thresholds, or to identify overfitting, underfitting, or dataset bias. In some embodiments, the processing system may be configured to calibrate a classification threshold, a detection threshold, an anomaly threshold, or a confidence output with held-out validation sequences. In some embodiments, the processing system may be configured to sweep one or more threshold values or one or more confidence calibration parameters over the held-out validation sequences, identify one or more values that satisfy a selected tradeoff between missed detections and false alarms or between confidence reliability and acceptance rate, and store the one or more values for later deployment with the model. In some embodiments, the processing system may be configured to verify that the model generalizes beyond the training set before later deployment to an SoC or a radar subsystem.

In block 710, the processing system may optimize or enhance the model for execution on a processing system, SoC, radar subsystem, or another deployment target. In some embodiments, the processing system may be configured to quantize parameters of the model, prune parameters of the model, reorder one or more memory layouts, compile one or more graph segments for a selected accelerator, and partition execution of the model across a central processing unit, a digital signal processor, a graphics processing unit, a neural processing unit, a field-programmable gate array, or an application-specific integrated circuit before deploying the model. In some embodiments, the processing system may be configured to calibrate one or more quantization scales with a calibration dataset and to profile the model on a target platform to determine a latency, a throughput, a memory footprint, a buffer size, a bandwidth demand, or an energy draw associated with one or more runtime profiles.

In some embodiments, the processing system may be configured to convert a temporal layer of the model into a recurrent form before deploying the model when the temporal layer admits a state-space realization. In some embodiments, the processing system may be configured to replace one or more training-time temporal kernels or one or more blockwise temporal operators with one or more runtime recurrent state-update operators that preserve modeled temporal behavior while reducing buffering or memory traffic during streaming inference on the deployment target. In some embodiments, the processing system may be configured to generate an execution package that includes model parameters, one or more compiled kernels, one or more threshold values, one or more runtime policies, one or more memory allocation plans, and one or more interface definitions for a target environment. In some embodiments, the processing system may be configured to align the model with the compute budget, memory budget, bandwidth budget, and latency budget of a deployment target before runtime radar data reaches the deployment target.

In block 712, the processing system may deploy the model to the SoC for generating an inference result from runtime digital I/Q baseband samples. In some embodiments, the processing system may be configured to transfer an execution package for the model to non-volatile storage or firmware memory associated with the SoC, load one or more model weights and one or more compiled operators into on-chip or off-chip memory during boot or initialization, and register one or more runtime interfaces through which runtime digital I/Q baseband samples enter the model and one or more inference results exit the model. In some embodiments, the processing system may be configured to deploy the model as a shared library, a firmware image, a graph executable, a hardware accelerator configuration, a containerized service, or a combination of software instructions and hardware configuration data depending on a selected radar subsystem architecture.

In some embodiments, the processing system may be configured to connect the deployed model to a runtime pipeline in which a radar receiver or a radar preprocessing stage supplies runtime digital I/Q baseband samples, the SoC executes the model on the runtime digital I/Q baseband samples, and one or more downstream components receive one or more inference results that include a waveform classification output, a signal-detection output, a target-identification output, an anomaly-detection output, or one or more parameter-estimation outputs. In some embodiments, the processing system may be configured to log runtime digital I/Q baseband samples and corresponding labels or inference results after deploying the model. In some embodiments, the processing system may be configured to store runtime digital I/Q baseband samples, one or more inferred labels, one or more operator-provided labels, one or more confidence values, and one or more metadata values in a field-data repository that later supports threshold refresh, validation refresh, retraining, or model replacement.

In some embodiments, the processing system may be configured to retrain the model with the runtime digital I/Q baseband samples and the corresponding labels or inference results after collecting the runtime digital I/Q baseband samples and the corresponding labels or inference results from deployed operation. In some embodiments, the processing system may be configured to place a trained and optimized model into a runtime radar processing path so that a deployment target generates decision-level outputs from live digital I/Q baseband samples with the temporal modeling, learned downsampling behavior, threshold calibration, and recurrent execution behavior established during training, validation, optimization, and retraining.

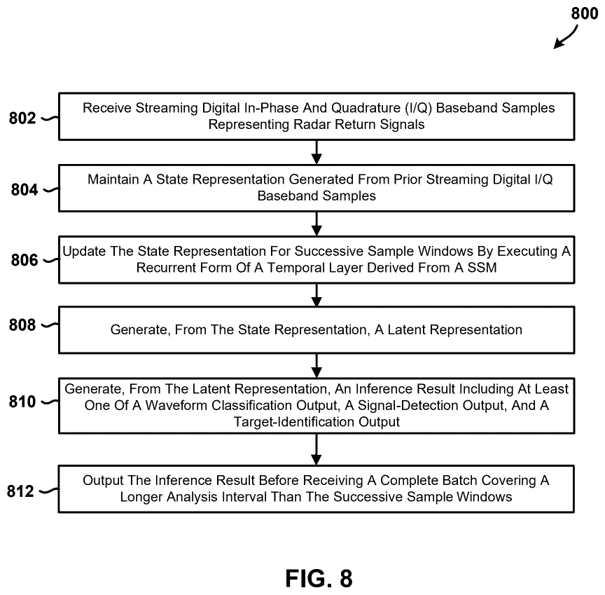

FIG. 8 is a process flow diagram illustrating a method 800 for low-latency processing of radar signals in accordance with some embodiments. Method 800 may be performed by a processing system in a computing device that includes one or more processors, one or more memories, and one or more interfaces coupled to a radar receiver or a radar signal source. In some embodiments, the processing system may be configured to convert a trained temporal convolution layer into a recurrent form before receiving the streaming digital I/Q baseband samples when the trained temporal convolution layer admits a state-space realization. In some embodiments, the processing system may be configured to derive one or more recurrent state-update operators and one or more output operators from one or more trained temporal kernels or one or more trained blockwise temporal operators, store one or more recurrent parameters in memory associated with the computing device, and load the one or more recurrent parameters into one or more runtime execution units before live streaming inference begins. In some embodiments, the processing system may be configured to preserve modeled temporal behavior while reducing buffering and memory traffic during streaming inference by replacing one or more training-time temporal operators with one or more recurrent state updates that operate on successive sample windows. In some embodiments, the processing system may be configured to allocate execution of the recurrent form to a low-power accelerator in the SoC while allocating radar front-end conditioning to a digital signal processor in the SoC. In some embodiments, the processing system may be configured to assign one or more filtering, normalization, synchronization, gain-control, or I/Q correction operations to the digital signal processor and assign one or more recurrent state updates, latent-feature generation operations, and task-head operations to a neural processing unit, a low-power matrix engine, or another accelerator that executes the recurrent form with reduced energy draw.

In block 802, the processing system may receive streaming digital in-phase and quadrature (I/Q) baseband samples representing radar return signals. In some embodiments, the processing system may be configured to receive the streaming digital I/Q baseband samples from a radar receiver front end that downconverts radio-frequency radar returns to baseband and digitizes the baseband with one or more analog-to-digital converters, after which a direct memory access engine transfers successive groups of the streaming digital I/Q baseband samples into one or more memory buffers accessible to the processing system. In some embodiments, the processing system may be configured to receive the streaming digital I/Q baseband samples as paired I samples and Q samples, as a two-channel tensor, or as one or more interleaved buffers that identify a temporal order for sample-by-sample or window-by-window processing. In some embodiments, the processing system may be configured to receive, with the streaming digital I/Q baseband samples, one or more metadata values that identify a time stamp, a pulse index, a chirp index, a dwell index, a beam identifier, an antenna channel, a range gate, a radar mode, a sampling rate, a pulse repetition interval, or a receiver gain value.

In some embodiments, the processing system may be configured to perform radar front-end conditioning on the streaming digital I/Q baseband samples before recurrent processing begins. In some embodiments, the processing system may be configured to apply one or more gain normalization operations, one or more DC offset removal operations, one or more I/Q imbalance correction operations, one or more timing alignment operations, one or more synchronization operations, or one or more channel-selection operations in the digital signal processor so that later recurrent processing receives temporally ordered and conditioned input data. In some embodiments, the processing system may be configured to partition the streaming digital I/Q baseband samples into successive sample windows that each contain a selected number of consecutive samples, pulse segments, chirp segments, or short temporal patches so that the recurrent form processes a defined unit of streaming input while a longer analysis interval remains incomplete.

In block 804, the processing system may maintain a state representation generated from prior streaming digital I/Q baseband samples. In some embodiments, the processing system may be configured to store the state representation as one or more vectors, matrices, or structured state tensors in on-chip memory, shared memory, local cache, or another fast-access memory region so that the state representation remains available between successive sample windows. In some embodiments, the processing system may be configured to maintain the state representation as a compact summary of temporal information extracted from prior streaming digital I/Q baseband samples, with the state representation carrying forward one or more temporal dependencies that extend beyond a current sample window. In some embodiments, the processing system may be configured to limit buffering of the streaming digital I/Q baseband samples to the successive sample windows and the state representation.

In some embodiments, the processing system may be configured to release one or more earlier raw sample buffers after the state representation has been updated for a current sample window so that runtime memory stores the current successive sample windows and the state representation rather than an entire longer analysis interval of raw radar data. In some embodiments, the processing system may be configured to reduce buffer depth, memory occupancy, and off-chip memory traffic by carrying forward the state representation instead of preserving a full-length raw history of the streaming digital I/Q baseband samples. In some embodiments, the processing system may be configured to reset the state representation in response to detecting a mode change, a data discontinuity, or a scan boundary. In some embodiments, the processing system may be configured to monitor one or more radar mode identifiers, one or more sequence counters, one or more timing gaps, one or more beam identifiers, or one or more continuity flags and initialize the state representation to zero, to a learned initialization vector, or to another reset state when the one or more radar mode identifiers, the one or more sequence counters, the one or more timing gaps, the one or more beam identifiers, or the one or more continuity flags indicate that temporal continuity no longer applies across adjacent sample windows. In some embodiments, the processing system may be configured to preserve the state representation across successive sample windows while the streaming data remains continuous and to discard the state representation when a continuity condition fails.

In block 806, the processing system may update the state representation for successive sample windows by executing a recurrent form of a temporal layer derived from an SSM. In some embodiments, the processing system may be configured to treat each successive sample window as an input vector sequence u_t and compute an updated state x_t from a prior state x_t−1 according to one or more learned recurrent state-update relations derived from a SSM, with one or more learned matrices, one or more structured kernels, one or more discretized continuous-time parameters, or one or more recurrent state-update operators stored in memory and applied at runtime.

In some embodiments, the processing system may be configured to execute the recurrent form on the low-power accelerator in the SoC so that each successive sample window updates the state representation with bounded arithmetic cost and bounded latency. In some embodiments, the processing system may be configured to derive the recurrent form from a temporal layer that was trained in a convolutional or blockwise form and later transformed into one or more runtime recurrent state updates when the temporal layer admits a state-space realization. In some embodiments, the processing system may be configured to propagate temporal information across a sequence of successive sample windows through the updated state representation so that temporal context spans a longer interval than any single successive sample window. In some embodiments, the processing system may be configured to execute one or more nonlinear activation operations, one or more normalization operations, one or more residual operations, or one or more projection operations before or after the recurrent state update when a selected recurrent architecture includes such operations. In some embodiments, the processing system may be configured to preserve real-time or near-real-time execution by updating the state representation incrementally for each successive sample window instead of waiting for a complete longer analysis interval.

In block 808, the processing system may generate, from the state representation, a latent representation. In some embodiments, the processing system may be configured to apply one or more learned projection layers, one or more normalization layers, one or more nonlinear activation functions, one or more pooling operations, or one or more readout operators to the state representation so that the state representation is transformed into a compact latent tensor, one or more token embeddings, a pooled latent vector, or another reduced-dimension feature representation. In some embodiments, the processing system may be configured to generate the latent representation from a current state representation alone or from a combination of the current state representation and one or more features extracted from a current successive sample window. In some embodiments, the processing system may be configured to represent waveform structure, temporal correlation, Doppler variation, micro-motion signatures, clutter characteristics, or interference patterns in the latent representation so that one or more downstream heads operate on a compact feature space rather than on raw streaming radar samples. In some embodiments, the processing system may be configured to compress the temporal content accumulated in the state representation into one or more task-relevant features that support low-latency inference from incomplete streaming data.

In block 810, the processing system may generate, from the latent representation, an inference result comprising at least one of a waveform classification output, a signal-detection output, and a target-identification output. In some embodiments, the processing system may be configured to apply one or more task heads to the latent representation, with a waveform classification head generating class scores over candidate waveform or modulation types, a signal-detection head generating one or more detection scores or one or more target-present indicators, and a target-identification head generating class scores over candidate target categories or target signatures. In some embodiments, the processing system may be configured to implement a task head as a fully connected layer stack, a linear classifier, a lightweight convolutional head, a recurrent readout head, or another learned decision module that receives the latent representation and outputs one or more logits, one or more scores, one or more labels, or one or more confidence values. In some embodiments, the processing system may be configured to generate the inference result as a single-task output or as a multi-task output that includes one or more waveform labels, one or more detection decisions, one or more target class labels, one or more confidence values, one or more anomaly scores, or one or more estimated radar parameters. In some embodiments, the processing system may be configured to derive an actionable decision from the latent representation before a complete longer analysis interval becomes available so that a downstream subsystem receives an early decision signal rather than waiting for a batch-complete inference cycle. In some embodiments, the processing system may be configured to combine a current inference result with one or more earlier inference results, one or more track states, or one or more temporal consistency rules so that transient noise and short-lived interference have reduced influence or impact on an output decision.

In block 812, the processing system may output the inference result before receiving a complete batch covering a longer analysis interval than the successive sample windows. In some embodiments, the processing system may be configured to write the inference result to a shared memory region, a controller register set, a message queue, a peripheral bus transaction, a network packet, or an application programming interface object as soon as the inference result satisfies one or more decision criteria associated with the current state representation and the current successive sample window. In some embodiments, the processing system may be configured to output the inference result to a radar controller, a tracker, a display device, or another downstream subsystem before raw sample acquisition reaches the end of the longer analysis interval that a non-streaming batch pipeline would otherwise require. In some embodiments, the processing system may be configured to format the inference result as a structured output record that includes one or more waveform identifiers, one or more detection flags, one or more target identifiers, one or more confidence values, one or more time stamps, one or more beam identifiers, one or more range-bin identifiers, or one or more track association identifiers. In some embodiments, the processing system may be configured to support low-latency radar decision-making by producing the inference result from the successive sample windows and the state representation while acquisition of later streaming digital I/Q baseband samples remains in progress. In some embodiments, the processing system may be configured to repeat blocks 802 through 812 for each new successive sample window so that method 800 operates as a continuous streaming inference pipeline with recurrent state carryover, bounded buffering, and early output generation.

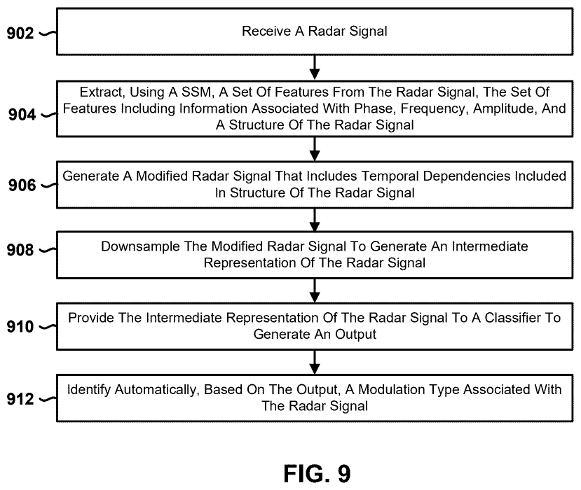

FIG. 9 is a process flow diagram illustrating a method 900 for processing radar signals in accordance with some embodiments. Method 900 may be performed by a processing system in a computing device that includes one or more processors, one or more memories, and one or more interfaces coupled to a radar receiver or a radar signal source. In some embodiments, the processing system may be configured to perform method 900 as a sequence of radar-signal acquisition, state-space feature extraction, radar-signal modification, downsampling, classification, and automatic modulation identification operations that execute in series, in parallel, or in a pipelined arrangement. In some embodiments, the processing system may be configured to load learned parameters for one or more SSMs, one or more classifier layers, one or more thresholds, and one or more runtime policies from a non-transitory computer-readable medium before processing a runtime radar signal.

In block 902, the processing system may receive a radar signal. In some embodiments, the processing system may be configured to, for example, receive the radar signal from a radar receiver front end that downconverts a radio-frequency return to baseband and digitizes the baseband with one or more analog-to-digital converters, after which a direct memory access engine transfers one or more resulting sample buffers into a memory region accessible to the processing system. In some embodiments, the processing system may be configured to receive the radar signal as digital in-phase and quadrature (I/Q) baseband samples, as a complex-valued sequence, as paired I and Q channels, or as one or more pulse, chirp, burst, frame, dwell, or range-gated segments that preserve temporal ordering. In some embodiments, the processing system may be configured to receive, with the radar signal, metadata that identifies a time stamp, a pulse index, a chirp index, a dwell index, a beam identifier, a receiver gain value, a sampling rate, a center frequency, a bandwidth, a pulse repetition interval, or a radar mode. In some embodiments, the processing system may be configured to preserve phase and amplitude content in the radar signal by ingesting the radar signal before conversion into an image-domain representation such as a spectrogram or a Wigner-Ville distribution. In some embodiments, the processing system may be configured to organize the radar signal into a defined unit of analysis so that later state-space processing operates on a temporally ordered input with known boundaries.

In block 904, the processing system may extract, using an SSM, a set of features from the radar signal, the set of features including information associated with phase, frequency, amplitude, and a structure of the radar signal. In some embodiments, the processing system may be configured to, for example, treat the radar signal as a time-ordered input sequence u_t and update a hidden state x_t according to one or more learned state-transition relations, with one or more output relations producing a feature sequence y_t whose channels encode temporal behavior observed in the radar signal. In some embodiments, the processing system may be configured to parameterize the SSM with one or more learned matrices, one or more structured kernels, one or more discretized continuous-time parameters, or one or more recurrent state-update operators stored in memory and applied across consecutive samples or sample groups. In some embodiments, the processing system may be configured to extract the set of features so that the set of features represents phase trajectories, instantaneous or local frequency behavior, amplitude envelopes, pulse structure, chirp structure, coding structure, Doppler variation, or temporal correlations present in the radar signal. In some embodiments, the processing system may be configured to capture long-range temporal dependencies with a fixed-dimension hidden state so that later operations act on a compact representation rather than on an unprocessed raw sequence alone. In some embodiments, the processing system may be configured to implement the SSM as an autoencoder. In some embodiments, the processing system may be configured to, for example, route the radar signal through an encoder portion of the autoencoder that compresses the radar signal into one or more latent states and through a decoder portion of the autoencoder that reconstructs one or more sequence outputs from the one or more latent states, with the one or more latent states and the one or more sequence outputs providing the set of features used in later processing.

In block 906, the processing system may generate a modified radar signal that includes temporal dependencies included in structure of the radar signal. In some embodiments, the processing system may be configured to, for example, generate the modified radar signal by propagating the radar signal through the SSM or the autoencoder so that the modified radar signal reflects one or more state-informed transformations that retain temporal relationships across multiple samples, pulses, chirps, or windows. In some embodiments, the processing system may be configured to generate the modified radar signal as a reconstructed sequence, a denoised sequence, a state-enhanced sequence, or another time-domain sequence that preserves task-relevant phase, frequency, amplitude, and structural information derived from the radar signal. In some embodiments, the processing system may be configured to generate the modified radar signal by reducing, using the SSM, a noise associated with the radar signal in the modified radar signal. In some embodiments, the processing system may be configured to, for example, suppress additive noise, receiver noise, clutter-related fluctuations, or impulsive interference by using the SSM to separate persistent temporal structure from non-persistent perturbations and reconstruct a cleaner sequence from one or more latent states. In some embodiments, the processing system may be configured to improve the signal quality of the modified radar signal before later downsampling and classification so that the classifier receives a temporally structured input with reduced contamination from noise. In some embodiments, the processing system may be configured to identify if an anomaly is included in the radar signal. In some embodiments, the processing system may be configured to, for example, compare the radar signal and the modified radar signal, compare one or more latent-state values against one or more reference ranges, compute one or more reconstruction residuals, or compute one or more anomaly scores from one or more hidden-state trajectories to determine whether the radar signal departs from learned nominal behavior. In some embodiments, the processing system may be configured to, based on detecting the anomaly, generate a flag indicating the modified radar signal is associated with a potential interference and/or unauthorized transmission. In some embodiments, the processing system may be configured to provide the flag to a memory location, a controller register, a message queue, a tracker input, or a display output so that a downstream subsystem reacts to possible interference, jamming, spoofing, or unauthorized emission conditions.

In block 908, the processing system may downsample the modified radar signal to generate an intermediate representation of the radar signal. In some embodiments, the processing system may be configured to, for example, apply a learned projection matrix, a tensor contraction, an Einstein-summation operation, a strided resampling operator, or another learned downsampling transformation to the modified radar signal. In some embodiments, the processing system may be configured to generate the intermediate representation of the radar signal by an SSM. In some embodiments, the processing system may be configured to, for example, apply an SSM before downsampling, during downsampling, or after an initial reduction stage so that the intermediate representation retains temporal dependencies represented by one or more state transitions instead of reflecting a purely fixed pooling operation. In some embodiments, the processing system may be configured to generate the intermediate representation as a compact sequence tensor, a latent feature map, a pooled state sequence, or another reduced-dimension representation that preserves task-relevant structural information from the modified radar signal. In some embodiments, the processing system may be configured to reduce sequence length and channel redundancy before classification so that later classifier operations consume less memory bandwidth and less arithmetic than classification on the full-resolution modified radar signal. In some embodiments, the processing system may be configured to select a resampling factor based on a radar mode, an available memory budget, an available latency budget, or an estimated signal-to-noise ratio.

In block 910, the processing system may provide the intermediate representation of the radar signal to a classifier to generate an output. In some embodiments, the processing system may be configured to, for example, route the intermediate representation to one or more classifier layers stored in memory and executed on one or more processor resources so that the classifier maps the intermediate representation to one or more logits, one or more class scores, one or more confidence values, or one or more ranked candidate labels. In some embodiments, the processing system may be configured to implement the classifier as a fully connected layer stack, a linear classifier, a lightweight neural network, a recurrent readout head, or another learned decision module that receives the intermediate representation and produces the output. In some embodiments, the processing system may be configured to implement the classifier as an SSM encoder. In some embodiments, the processing system may be configured to, for example, apply the intermediate representation to an SSM encoder that performs one or more additional state updates and one or more readout operations before producing the output, with the SSM encoder acting as a classifier backbone or as a classifier head. In some embodiments, the processing system may be configured to generate the output as a waveform score vector, a modulation score vector, one or more anomaly-related values, one or more signal-quality values, or one or more confidence-filtered candidate classes. In some embodiments, the processing system may be configured to transform the intermediate representation into a decision-oriented output so that later automatic identification operates on a compact classifier result instead of on the modified radar signal directly.

In block 912, the processing system may identify automatically, based on the output, a modulation type associated with the radar signal. In some embodiments, the processing system may be configured to, for example, apply one or more selection rules, one or more thresholds, one or more ranking operations, or one or more confidence filters to the output so that a modulation label or waveform label associated with the radar signal is selected from multiple candidate classes. In some embodiments, the processing system may be configured to identify automatically the modulation type as a pulse waveform class, a coded waveform class, a chirp class, a phase-coded class, a frequency-modulated class, an amplitude-modulated class, or another modulation or waveform category represented in a label map associated with the classifier. In some embodiments, the processing system may be configured to associate the identified modulation type with one or more metadata values that include a time stamp, a beam identifier, a dwell identifier, a confidence value, or an anomaly flag generated from block 906. In some embodiments, the processing system may be configured to output the identified modulation type to a radar controller, a tracker, a display device, a logging subsystem, or another downstream component for control, monitoring, or storage. In some embodiments, the processing system may be configured to repeat blocks 902 through 912 for successive radar signals so that method 900 supports automatic modulation identification for live runtime data, recorded radar datasets, or synthetic radar test sequences.

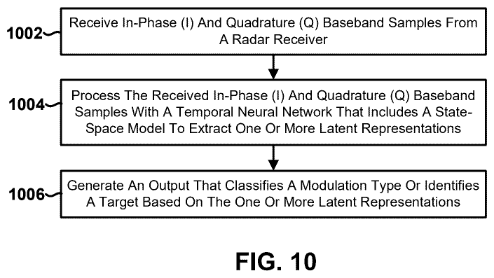

FIG. 10 is a process flow diagram illustrating a method 1000 for analyzing radar signals using a temporal neural network integrated with a SSM in accordance with some embodiments. Method 1000 may be performed by a processing system in a computing device that includes one or more processors, one or more memories, and one or more interfaces coupled to a radar receiver or a radar signal source. In some embodiments, the processing system may be configured to initialize one or more parameters of the SSM by defining at least one transition matrix or at least one observation matrix. In some embodiments, the processing system may be configured to, for example, define a transition matrix that governs hidden-state evolution across successive time indices, define an observation matrix that maps a hidden state to an output feature space, optionally define one or more input matrices or feedthrough matrices, and store the one or more matrices as learned parameters, constrained parameters, or initialized parameters in a memory associated with the computing device before runtime processing begins. In some embodiments, the processing system may be configured to train the temporal neural network by providing labeled examples of radar signals, in which each labeled example comprises a sequence of in-phase and quadrature baseband samples paired with a ground-truth modulation category or target label. In some embodiments, the processing system may be configured to, for example, organize the labeled examples into training batches, execute forward passes and backward passes through the temporal neural network and the SSM, compute one or more classification losses or target-identification losses, and update one or more parameters of the SSM or the temporal neural network with an optimization procedure that accounts for long-range dependencies in the received in-phase and quadrature baseband samples by training over extended temporal sequences and propagating gradients through temporally ordered state updates. In some embodiments, the processing system may be configured to convert one or more temporal convolution operations within the temporal neural network into equivalent recurrent operations during inference when the one or more temporal convolution operations admit a state-space realization. In some embodiments, the processing system may be configured to, for example, derive one or more recurrent state-update operators and one or more output operators from one or more trained temporal kernels, store one or more recurrent coefficients in memory, and load the one or more recurrent coefficients into one or more runtime execution units before live inference begins so that streaming inference proceeds with reduced buffering on embedded hardware. In some embodiments, the processing system may be configured to buffer only a limited quantity of incoming in-phase and quadrature baseband samples for conversion to recurrent operations so that low-latency processing occurs without preserving a full-length raw history of a longer analysis interval.

In block 1002, the processing system may receive in-phase and quadrature baseband samples from a radar receiver. In some embodiments, the processing system may be configured to, for example, receive the in-phase and quadrature baseband samples from a radar receiver front end that downconverts a radio-frequency radar return to baseband and digitizes the baseband with one or more analog-to-digital converters, after which a direct memory access engine transfers the in-phase and quadrature baseband samples into one or more memory buffers accessible to the processing system. In some embodiments, the processing system may be configured to receive the in-phase and quadrature baseband samples as paired I samples and Q samples, as a complex-valued sample stream, or as a two-channel tensor arranged according to time order. In some embodiments, the processing system may be configured to receive, with the in-phase and quadrature baseband samples, one or more metadata values that identify a sampling rate, a pulse repetition interval, a radar mode, a beam identifier, an antenna channel, a center frequency, a bandwidth, a gain value, a time stamp, or a capture source. In some embodiments, the processing system may be configured to receive the in-phase and quadrature baseband samples from at least one radar platform selected from defence, maritime, weather monitoring, aviation, or autonomous vehicle systems. In some embodiments, the processing system may be configured to, for example, receive the in-phase and quadrature baseband samples from a shipboard radar subsystem, a weather radar installation, an air-surveillance radar, an automotive radar module, or a defence radar platform through one or more live receiver interfaces or one or more replay buffers. In some embodiments, the processing system may be configured to partition the in-phase and quadrature baseband samples into one or more windows, pulses, chirps, bursts, frames, or dwells so that later temporal processing operates on a defined temporal unit.

In block 1004, the processing system may process the received in-phase and quadrature baseband samples with a temporal neural network that includes a SSM to extract one or more latent representations. In some embodiments, the processing system may be configured to, for example, apply an SSM-based encoder across the temporally ordered in-phase and quadrature baseband samples so that one or more hidden states update according to one or more learned transition relations and one or more encoded outputs capture extended temporal correlations present in the in-phase and quadrature baseband samples. In some embodiments, the processing system may be configured to implement the temporal neural network with an SSM-based encoder that captures extended temporal correlations in the in-phase and quadrature baseband samples and outputs the one or more latent representations to a classifier head. In some embodiments, the processing system may be configured to downsample the one or more latent representations by applying a learned projection matrix that reduces a temporal dimension of the radar signals and retains amplitude and spectral features. In some embodiments, the processing system may be configured to, for example, apply the learned projection matrix to one or more consecutive temporal segments of an encoded sequence so that an input feature space maps to a reduced representation that preserves time-dependent features relevant for the classification or detection output while decreasing sequence length and arithmetic cost for later classifier processing.

In some embodiments, the processing system may be configured to generate the one or more latent representations with one or more parallelizable matrix operations that update states of the SSM, thereby allowing simultaneous processing of multiple time steps on a graphics processing unit or equivalent hardware accelerator. In some embodiments, the processing system may be configured to, for example, execute one or more batched matrix multiplications, one or more scan-style state updates, or one or more blockwise sequence transforms on accelerator hardware so that multiple time indices are processed in parallel during training, calibration, or batch inference. In some embodiments, the processing system may be configured to apply a decoder to reconstruct the in-phase and quadrature baseband samples from the one or more latent representations for denoising or anomaly detection. In some embodiments, the processing system may be configured to, for example, propagate the one or more latent representations through one or more decoder layers that reconstruct a cleaned sequence and compare the cleaned sequence with the received in-phase and quadrature baseband samples so that reconstruction error, latent inconsistency, or another deviation measure supports noise reduction or anomaly detection. In some embodiments, the processing system may be configured to adapt one or more parameters of the SSM or the temporal neural network based on at least one environmental factor, including changes in signal-to-noise ratio or multipath conditions. In some embodiments, the processing system may be configured to, for example, select one or more parameter sets, adjust one or more gain factors, modify one or more normalization parameters, or alter one or more downsampling settings in response to an estimated signal-to-noise ratio, a detected multipath condition, a clutter level, or another environmental factor so that the extracted one or more latent representations remain informative under changing operating conditions. In some embodiments, the processing system may be configured to reduce raw-signal dimensionality while preserving temporally extended structure in the one or more latent representations so that later classification or target identification operates on a compact and task-relevant feature space.

In block 1006, the processing system may generate an output that classifies a modulation type or identifies a target based on the one or more latent representations. In some embodiments, the processing system may be configured to, for example, provide the one or more latent representations to a classifier head that includes one or more fully connected layers, with the one or more fully connected layers producing one or more logits, one or more scores, or one or more labels that indicate the modulation type or the target class. In some embodiments, the processing system may be configured to generate the output as a waveform classification output, a modulation-type output, a target-identification output, or a multi-task output that includes a class label and one or more auxiliary values. In some embodiments, the processing system may be configured to generate a confidence score that indicates a likelihood of a particular modulation scheme or target class. In some embodiments, the processing system may be configured to, for example, apply one or more softmax operations, one or more sigmoid operations, one or more thresholds, one or more ranking operations, or one or more confidence-calibration parameters to classifier-head outputs so that the output includes a predicted class and a corresponding confidence score. In some embodiments, the processing system may be configured to identify the target as an aircraft, a drone, a vehicle, clutter, or another target class represented in a label set associated with the classifier head, or to identify the modulation type as a linear frequency modulated waveform, a phase-coded waveform, a Barker-coded waveform, a Frank-coded waveform, a polyphase waveform, or another radar waveform class represented in the label set. In some embodiments, the processing system may be configured to output the class label and the confidence score to a display device, a tracker, a controller, a logging module, or another downstream subsystem so that decision-level information becomes available without manual feature analysis.

Some embodiments may include a computing system that includes a memory and a processing system coupled to the memory. The processing system may include at least one processor configured to receive a raw input signal and to process the raw input signal through an encoder path. In some embodiments, the encoder path may include one or more downsample blocks that reduce a temporal resolution of the raw input signal while increasing a channel dimension using learned resampling operations, and the encoder path may include one or more state space model (SSM) blocks that apply structured state transition operations across a time dimension to generate a bottleneck representation. In some embodiments, the processing system is further configured to process the bottleneck representation through a decoder path that may include one or more upsample blocks that increase the temporal resolution while reducing the channel dimension using learned inverse transformations, and the decoder path further may include one or more SSM blocks that apply structured state transition operations to refine a reconstructed signal representation. In some embodiments, the processing system is further configured to apply skip connections between corresponding encoder and decoder blocks to preserve fine-grained temporal information during reconstruction. In some embodiments, the processing system is further configured to generate a denoised output signal from the decoder path, and the denoised output signal is used for real-time enhancement of the raw input signal.

Some embodiments include a non-transitory processor-readable storage medium that has stored thereon data and configurations to control a state machine or cause a processing system to perform operations that include receiving a raw input signal and processing the raw input signal through an encoder path. In some embodiments, the encoder path may include one or more downsample blocks that reduce a temporal resolution of the raw input signal while increasing a channel dimension using learned resampling operations, and the encoder path further may include one or more state space model (SSM) blocks that apply structured state transition operations across a time dimension to generate a bottleneck representation. In some embodiments, the operations further include processing the bottleneck representation through a decoder path that may include one or more upsample blocks that increase the temporal resolution while reducing the channel dimension using learned inverse transformations, and the decoder path further may include one or more SSM blocks that apply structured state transition operations to refine a reconstructed signal representation. In some embodiments, the operations further include applying skip connections between corresponding encoder and decoder blocks to preserve fine-grained temporal information during reconstruction. In some embodiments, the operations further include generating a denoised output signal from the decoder path, and the denoised output signal is used for real-time enhancement of the raw input signal.

Some embodiments may include methods for adaptive control of a radar system based on modulation-type identification from digital in-phase and quadrature (I/Q) baseband samples is performed by a computing system coupled to a radar receiver and a radar controller. In some embodiments, the method may include receiving, by the computing system, a radar signal including digital I/Q baseband samples. In some embodiments, the method may include generating, by the computing system and with a state space model (SSM), an intermediate sequence including SSM output features that represent temporal dependencies of the digital I/Q baseband samples. In some embodiments, the method may include downsampling, by the computing system, the intermediate sequence by applying a learned downsampling transformation that reduces a sequence length and maps input channels to output channels to form a downsampled intermediate representation. In some embodiments, the method may include generating, by the computing system, a classifier output by providing the downsampled intermediate representation to a classifier. In some embodiments, the method may include identifying, by the computing system and from the classifier output, a modulation type associated with the radar signal. In some embodiments, the method may include updating, by the computing system, the radar system by generating radar-control data that specifies at least one of a threshold setting, a dwell allocation, a waveform schedule, and an assignment of resource priority and by providing the radar-control data to the radar controller.

Some embodiments may include methods for processing radar signals that is performed by a computing system having one or more processors and one or more memories. In some embodiments, the method may include receiving a radar signal. In some embodiments, the method may include extracting, using a state space model (SSM), a set of features from the radar signal, and the set of features may include information associated with phase, frequency, amplitude, and a structure of the radar signal. In some embodiments, the method may include generating a modified radar signal that may include temporal dependencies included in the structure of the radar signal. In some embodiments, the method may include downsampling the modified radar signal to generate an intermediate representation of the radar signal. In some embodiments, the method may include providing the intermediate representation of the radar signal to a classifier to generate an output. In some embodiments, the method may include identifying automatically, based on the output, a modulation type associated with the radar signal. In some embodiments, the method may include sending data to adapt a radar operation based on the identification of the modulation type associated with the radar signal, and the radar operation is associated with at least one of a threshold setting, a dwell allocation, a waveform schedule, and assignment of resource priority.

In some embodiments of the method for processing radar signals, generating the modified radar signal may include reducing, using the state space model (SSM), a noise associated with the radar signal in the modified radar signal. In some embodiments, generating the modified radar signal may include identifying whether an anomaly is included in the radar signal and, based on detecting the anomaly, generating a flag indicating the modified radar signal is associated with a potential interference and/or unauthorized transmission. In some embodiments, the classifier may be an SSM encoder. In some embodiments, the SSM may be an autoencoder. In some embodiments, the intermediate representation of the radar signal may be generated by a SSM.

In some embodiments, a computing device may include a memory and a processing system coupled to the memory, and the processing system may include at least one processor configured to receive a signal. In some embodiments, the signal may include a radar signal, and the processing system is configured to extract, using a state space model (SSM) autoencoder, a set of features from the radar signal, and the set of features retains a structure of the radar signal. In some embodiments, the processing system is further configured to generate a modified radar signal that may include temporal dependencies in the structure of the radar signal and to downsample the modified radar signal to generate an intermediate representation of the radar signal. In some embodiments, the processing system is further configured to provide the intermediate representation of the radar signal to a classifier to generate an output and to identify automatically, based on the output, a modulation type associated with the radar signal. In some embodiments, the processing system is further configured to send an indication of the identification of the modulation type, and the indication is configured to induce a radar controller to update a sensing mode or a scheduling decision associated with the radar controller, to induce a tracker to initialize, update, confirm, or suppress a target track, or to induce a display device to render a label, an alert, a value, or a target icon associated with the signal.

In some embodiments, a non-transitory processor-readable storage medium has stored thereon data and configurations to control a state machine or cause a processing system to perform operations that include receiving a radar signal. In some embodiments, the operations include extracting, using a state space model (SSM), a set of features from the radar signal, and the set of features may include information associated with phase, frequency, amplitude, and a structure of the radar signal. In some embodiments, the operations include generating a modified radar signal that may include temporal dependencies included in the structure of the radar signal and downsampling the modified radar signal to generate an intermediate representation of the radar signal. In some embodiments, the operations include providing the intermediate representation of the radar signal to a classifier to generate an output and identifying automatically, based on the output, a modulation type associated with the radar signal. In some embodiments, the operations include sending data to adapt a radar operation based on the identification of the modulation type associated with the radar signal, and the radar operation is associated with at least one of a threshold setting, a dwell allocation, a waveform schedule, and assignment of resource priority.

Some embodiments may include a method for analyzing radar signals using a temporal neural network integrated with a state space model may include receiving in-phase and quadrature baseband samples from a radar receiver. In some embodiments, the method may include processing the received in-phase and quadrature baseband samples with a temporal neural network that may include a state space model to extract one or more latent representations. In some embodiments, the method may include generating an output that classifies a modulation type or identifies a target based on the one or more latent representations. In some embodiments, the method may include adapting, based on the modulation type or the target, a radar operation including at least one of adjusting a detection threshold, selecting a waveform from a waveform library, updating a dwell allocation, and modifying a resource priority of the computing system.

In some embodiments, the method for analyzing radar signals using the temporal neural network integrated with the state space model may include initializing one or more parameters of the state space model by defining at least one transition matrix or at least one observation matrix. In some embodiments, the method for analyzing radar signals using the temporal neural network integrated with the SMM may include downsampling the one or more latent representations by applying a learned projection matrix that reduces a temporal dimension of the radar signals and retains amplitude and spectral features.

In some embodiments of the method for analyzing radar signals using the temporal neural network integrated with the state space model, the temporal neural network may include an SSM-based encoder that captures extended temporal correlations in the in-phase and quadrature baseband samples and outputs the one or more latent representations to a classifier head. In some embodiments of the method including the SSM-based encoder and the classifier head, the method further may include applying a decoder to reconstruct the in-phase and quadrature baseband samples from the one or more latent representations for denoising or anomaly detection. In some embodiments of the method including the classifier head, the classifier head may include one or more fully connected layers that receive the one or more latent representations and produce an output indicating the modulation type or a target class. In some embodiments of the method for analyzing radar signals using the temporal neural network integrated with the state space model, the method further may include converting one or more temporal convolution operations within the temporal neural network into equivalent recurrent operations during inference, reducing memory usage and enabling real-time analysis on embedded hardware. In some embodiments of the method for analyzing radar signals using the temporal neural network integrated with the state space model, the method further may include adapting one or more parameters of the state space model or the temporal neural network based on at least one environmental factor, including changes in signal-to-noise ratio or multipath conditions. In some embodiments of the method for analyzing radar signals using the temporal neural network integrated with the state space model, the temporal neural network may include parallelizable matrix operations that update states of the state space model, and the parallelizable matrix operations allow simultaneous processing of multiple time steps on a graphics processing unit or an equivalent hardware accelerator. In some embodiments of the method for analyzing radar signals using the temporal neural network integrated with the state space model, the method further may include training the temporal neural network by providing labeled examples of radar signals, and each labeled example may include a sequence of in-phase and quadrature baseband samples paired with a ground-truth modulation category or a target label.

In some embodiments of the method including the learned projection matrix, the learned projection matrix performs downsampling by mapping an input feature space to a reduced representation that preserves time-dependent features relevant for the classification output or the detection output. In some embodiments of the method including initialization of the one or more parameters of the state space model, the one or more parameters of the state space model are updated using an optimization procedure that accounts for long-range dependencies in the received in-phase and quadrature baseband samples. In some embodiments of the method for analyzing radar signals using the temporal neural network integrated with the state space model, the method further may include buffering only a limited quantity of incoming in-phase and quadrature baseband samples for conversion to recurrent operations, thereby enabling low-latency processing. In some embodiments of the method for analyzing radar signals using the temporal neural network integrated with the state space model, the output that classifies a modulation type or identifies a target may include generating a confidence score that indicates the likelihood of a particular modulation scheme or a target class. In some embodiments of the method for analyzing radar signals using the temporal neural network integrated with the state space model, the radar signals originate from at least one radar platform selected from defence systems, maritime systems, weather monitoring systems, aviation systems, and autonomous vehicle systems.

As discussed, some embodiments may use temporal neural networks, such as TENNs, with SSMs to provide enhanced temporal modeling for real-time radar operations in diverse environments. TENNs are an advanced class of neural network architectures specifically designed to process sequential or time-series data, characterized by temporal dependencies and evolving dynamics. TENNs use structured temporal kernels, which allow them to capture complex, long-range temporal correlations in data more efficiently and accurately than conventional approaches like standard Temporal Convolutional Networks (TCNs), RNNs, or Transformers.

Some embodiments may use TENNs integrated with SSM, for radar signal processing. These embodiments may offer significant improvements in radar signal processing tasks, including AMC and detection. These TENNs-based systems may combine superior temporal modeling capabilities with low computational overhead, enhancing both accuracy and real-time performance, thereby representing a substantial advancement over existing radar processing techniques.

Some embodiments may include an SSM-based encoder that transforms raw I/Q baseband sequences into a compact latent feature representation. The encoder may apply one or more SSM blocks and structured downsampling operations to extract temporal features while reducing sequence length. The resulting latent representation may be provided directly to a classification head for radar waveform classification, modulation classification, or target identification. The encoder-classifier pipeline may enable efficient feature extraction from high-dimensional sequential data while maintaining low memory usage and real-time processing capability.

Some embodiments may include an SSM-based autoencoder including an encoder and a decoder. The encoder compresses raw I/Q sequences into a latent state representation using structured state-space transitions. The decoder reconstructs the input signal from the latent representation using learned inverse transformations. A reconstruction loss may be combined with a classification loss during training to improve feature robustness. The latent representation generated by the encoder may also be provided to a classifier head for waveform or target classification tasks.

Some embodiments may include radar signal processing methods and systems that integrate temporal neural networks with SSMs, combined with an autoencoder-based architecture to efficiently process and classify radar signals in real-time. Disclosed embodiments include systems and methods that significantly advance AMC, target detection, and radar signal characterization by overcoming the limitations of traditional deep learning models, which require extensive preprocessing and computationally expensive transformations such as Wigner-Ville Distribution (WVD) or FFT. By enabling direct processing of raw in-phase and quadrature baseband signals, the embodiments disclosed circumvent processes for handcrafted feature extraction, reducing latency and computational overhead while improving classification accuracy.

Some embodiments disclosed include an SSM-based autoencoder, which effectively extracts structured representations from radar signals by capturing long-range dependencies in a computationally efficient manner. The encoder compresses the high-dimensional radar signal into a compact latent representation, which is then fed into a classifier head for decision-making. Unlike traditional RNNs or Transformer-based models, which involve from high memory consumption and sequential bottlenecks, SSMs allow parallel processing, enabling real-time classification, detection, and tracking on resource-constrained hardware.

Embodiments disclosed include systems and/or methods that implement a downsampling mechanism that optimally reduces the temporal resolution of the signal while preserving its spectral and amplitude characteristics. This downsampling is performed using a structured resampling operation, wherein learned transformation matrices reduce the sequence length adaptively based on the radar signal characteristics. Unlike conventional pooling methods, which risk losing critical signal information, the SSM-based downsampling preserves essential modulation features, enhancing classification performance and robustness against noise, interference, and multipath propagation.

Disclosed systems and methods support real-time performance and are further reinforced by the ability to convert temporal convolution layers into equivalent recurrent layers during inference, thereby reducing buffering requirements and enabling deployment on low-power embedded systems and mobile radar platforms. The disclosed embodiments are designed for high-speed, real-time applications, making it particularly valuable for defense radar systems, electronic warfare, spectrum monitoring, cognitive radar, and autonomous vehicle sensing.

By integrating SSM-based feature extraction, an autoencoder-driven classifier, adaptive downsampling, and direct I/Q signal processing, the embodiment delivers a highly scalable, low-latency, and computationally efficient solution for radar signal classification and detection, setting a new benchmark for real-time radar analytics.

The processing module may include a unique TENNs architecture augmented with SSM layers, designed specifically for handling complex radar signals exhibiting temporal variations and long-range dependencies. Conventional radar processing methods, including those based on CNNs and RNNs, often fall short in modeling extended temporal correlations or require extensive computational resources, making real-time processing challenging. In contrast, TENNs integrated with SSM overcome these limitations by efficiently capturing temporal structures in radar signals.

An SSM-based autoencoder leverages the structured mathematical representation of dynamical systems to efficiently process sequential data. Unlike traditional deep learning models that rely on recurrent structures (such as LSTMs) or self-attention mechanisms (as in Transformers), SSM-based autoencoders take advantage of linear and stable state-space representations to handle long-range dependencies with reduced computational complexity.

An autoencoder generally includes two components: the encoder, which compresses input data into a latent representation, and the decoder, which reconstructs the original data from this compressed form. In the case of an SSM-based autoencoder, the encoding process relies on SSM dynamics, where input sequences are transformed into latent states through structured state transitions. The decoder then reconstructs the signal by propagating the learned states through an inverse transformation.

The advantage of using SSMs in autoencoders lies in their structured approach to modeling time-dependent relationships. The state transitions are governed by a set of learned system matrices, ensuring that the model captures both short-term variations and long-term dependencies effectively. Additionally, SSMs provide a continuous-time framework, making them particularly well-suited for signals sampled at different rates.

Radar and RF signals are highly sequential and contain both amplitude and phase information that must be preserved for accurate processing. SSM-based autoencoders offer a powerful approach to handling these signals due to the following reasons:

Feature Extraction from I/Q Data: In-phase (I) and quadrature (Q) radar signals encode essential phase and amplitude details. An SSM-based autoencoder may efficiently compress and reconstruct these signals while preserving their inherent structure, enabling better modulation classification and target detection.

Noise Reduction and Denoising: In radar applications, clutter and interference are common challenges. SSM-based autoencoders have been successfully applied for speech enhancement and denoising by leveraging structured state-space dynamics to suppress noise while preserving critical signal features. The same principle may be extended to radar signals to enhance detection accuracy in noisy environments.

Anomaly Detection and Spectrum Monitoring: Since radar and RF signals are often subject to interference and adversarial conditions, an SSM-based autoencoder may detect anomalies by learning a baseline distribution of normal signals. Deviations from this learned representation may be flagged as potential interference, jamming, or unauthorized transmissions.

A downsampling process is used in adapting SSM-based architectures for efficient processing of radar and RF signals, particularly in deep learning applications. This approach reduces the sequence length of the input data while preserving the underlying signal structure, enabling computational efficiency without significant loss of information.

The function works by first applying an SSM block, which incorporates temporal dependencies in the input signal. This initial step ensures that the relevant features of the signal are already transformed into a meaningful representation before downsampling occurs. The downsampling process uses the Einstein summation notation transformation, which allows for structured downsampling while maintaining the integrity of the learned feature representations. Specifically, this transformation reshapes the input sequence by reducing its temporal resolution by a resampling factor, while simultaneously projecting the feature space from input channels to output channels. This transformation ensures that the network may still capture long-range dependencies in the radar signal while significantly reducing computational complexity.

Unlike traditional downsampling techniques such as simple averaging or max-pooling, this method employs a learned projection matrix, which provides a trainable way to optimize the feature reduction. This allows the model to learn an optimal downsampling strategy that aligns with the characteristics of radar and RF signals, rather than relying on a fixed, hand-engineered pooling mechanism. This technique ensures that the most relevant temporal and spectral features are retained while discarding redundant information.

The significance of this downsampling approach in the context of radar and RF signal processing is substantial. Radar signals often contain long-range dependencies and require high temporal resolution for effective classification, modulation recognition, or target detection. By leveraging an SSM-based architecture, the method allows for efficient parallelization on GPUs, a key advantage over traditional RNN-based methods that struggle with long sequence modeling due to sequential dependencies. Additionally, the learned downsampling process reduces the memory footprint, making it feasible to train deeper models without excessive computational overhead.

This approach represents a novel integration of structured downsampling within SSM-based architectures for radar and RF signal classification. Its unique contributions include (1) the use of trainable downsampling matrices instead of fixed pooling methods, (2) maintaining long-range temporal dependencies while reducing computational cost, and (3) enabling efficient training on large-scale RF datasets. This innovation positions the approach as a state-of-the-art solution for AMC, radar target detection, and signal characterization in real-world scenarios.

In AMC, the goal is to automatically identify the modulation scheme of a received signal without prior knowledge of the transmitter's parameters. This is critical for cognitive radio systems, electronic warfare, and spectrum monitoring, where real-time signal classification is essential. Traditional deep learning models for AMC typically process raw In-Phase (I) and Quadrature (Q) data or time-frequency representations such as spectrograms. However, these methods either require significant computational resources (as in Transformers) or struggle with long-range dependencies (as in RNNs).

SSM-based encoders offer a superior alternative by directly modeling the evolution of signal states over time, preserving both amplitude and phase information critical for modulation recognition. By learning structured representations of sequential radar signals, SSM encoders may efficiently distinguish between modulation types even in noisy or adversarial environments. Their ability to process variable-length sequences without performance degradation further enhances their applicability in real-world AMC scenarios.

Target identification in radar systems involves classifying detected objects based on their radar returns, distinguishing between aircraft, ground vehicles, drones, or clutter. Conventional classification methods rely on feature extraction from radar cross-section (RCS) variations, Doppler signatures, or time-frequency analyses. However, traditional neural networks often require handcrafted features or fail to generalize well across different operational conditions.

SSM-based encoders provide a continuous-time, state-driven approach to feature extraction, automatically learning representative patterns from raw radar data. Unlike conventional CNN-based classifiers, which focus on spatial dependencies, SSM encoders specialize in temporal pattern recognition, making them well-suited for identifying target motion profiles, detecting micro-Doppler signatures, and distinguishing between complex radar signatures. This capability enhances performance in defense, autonomous navigation, and air traffic monitoring applications.

The SSM encoder operates by receiving raw in-phase and quadrature baseband signals or time-frequency representations (such as spectrograms or Wigner-Ville Distributions). These signals are then transformed into latent state representations using structured state-space transitions, ensuring that the encoder retains phase, frequency, and amplitude information across extended sequences. Once the encoder has generated a latent representation of the input signal, this information is fed into a classifier head for final classification. The classifier head, typically a fully connected neural network or a lightweight CNN/RNN module, processes these latent features to distinguish between different modulation types in AMC or to identify target signatures in radar-based target classification.

The advantage of connecting an SSM encoder to a classifier head lies in its ability to compress high-dimensional sequential data into a feature space that is both compact and information-rich. This process significantly reduces the computational overhead required for classification while maintaining high accuracy. The classifier head is responsible for making the decision on the classification task, whether it be distinguishing between modulation schemes or identifying moving targets based on Doppler and spectral signatures. The structured nature of the SSM encoder ensures that features extracted are invariant to noise and interference, improving robustness in real-world scenarios for Radar and RF Signal Classification.

The SSM-based encoder-classifier pipeline works in several key steps. First, the input radar signal, in raw I/Q form, is fed into the SSM encoder, which learns an optimized representation of the signal based on structured state-space transitions. This ensures that temporal dependencies and spectral characteristics are efficiently captured and preserved. The encoded signal representation is then passed to the classifier head, which assigns the final classification label using a combination of dense layers, softmax activations, or even lightweight recurrent layers for additional refinement.

### Example Implementations

The following example implementations of the disclosed systems and methods in AMC using TENNs demonstrate the feasibility and effectiveness of this novel approach in radar signal processing. The CNN-based approach relied on WVD for feature extraction, whereas the TENNs-based method leveraged SSM to learn temporal dependencies without the need for handcrafted transformations.

For training RadChar dataset, a publicly available dataset with 512-sample I/Q sequences, which enabled benchmarking against prior work in radar signal characterization was used. The TENN based classification model was modified to accommodate radar signals by adjusting input representations, increasing input channels for complex I/Q data, and optimizing the classification head with Global Average Pooling for efficient feature extraction. Hyperparameter tuning was conducted to improve stability and convergence, ensuring that the model effectively captured radar-specific features.

To improve generalization to real-world conditions, training was extended to the RadioML 2018 dataset, which provided longer sequences and a broader variety of modulation types. The transition from fixed 512-sample frames in RadChar to 1024-sample frames in RadioML required further adaptation of the SSM-based encoder, optimizing it for handling long-range dependencies while maintaining computational efficiency. Training on RadioML demonstrated the ability of TENNs to classify modulation types across diverse signal environments, particularly under low SNR conditions, where traditional deep learning models often degrade in performance.

The final trained model achieved 85.2% validation accuracy, demonstrating superior classification performance over CNN-based methods that relied on pre-trained feature extractors. Confusion matrix analysis confirmed that TENNs effectively classified coherent pulse train (CPT) and LFM signals, with minor misclassification between Polyphase Barker and Frank-coded waveforms, emphasizing the need for further refinements in distinguishing closely related radar waveforms.

These results validate SSM-based TENNs as a scalable, efficient, and robust approach for AMC, providing computationally efficient training on GPUs while eliminating the need for large-scale pre-training. This innovation in radar waveform classification offers a low-latency, real-time solution for cognitive radar systems, spectrum monitoring, and autonomous electronic warfare applications, demonstrating a significant advancement in neural network-based radar signal processing.

The training process demonstrated that SSM-based TENNs are highly effective for radar signal classification, particularly when processing raw I/Q baseband data rather than spectrogram images. The ability of SSMs to efficiently handle long-range dependencies allowed for robust classification, even under noisy and complex radar environments. Some embodiments include multi-task learning approaches, where the model not only classifies signals but also predicts signal parameters such as pulse width and pulse repetition intervals. Some embodiments include augmenting the dataset with SNR-based transformations that could further enhance the model's robustness in real-world scenarios.

For AMC, the classifier categorizes the signal into predefined modulation types based on learned features that highlight unique modulation characteristics. For target classification, the classifier recognizes distinct radar return signatures corresponding to different objects (e.g., drones, vehicles, aircraft), improving situational awareness in defense and surveillance applications. The decoder component of the autoencoder, if included, may reconstruct the original signal from the encoded representation, aiding in signal denoising and anomaly detection.

As shown, performance and the encoder-classifier framework has demonstrated superior results compared to conventional CNN and RNN-based architectures for radar and RF signal classification. One of the key findings from recent evaluations is that SSM-based models achieve higher accuracy with fewer parameters while maintaining low-latency processing, making them ideal for real-time embedded applications. Compared to traditional approaches, SSM encoders have shown significant improvements in classification accuracy, particularly in low SNR conditions, where traditional deep learning models tend to struggle due to their inability to maintain long-range dependencies effectively.

SSM-based autoencoders may provide performance on tasks such as AMC and radar target classification, with models trained on datasets like RadChar, with high precision in distinguishing modulation types even under heavy interference. Further, when compared to Transformer-based models, SSMs offer nearly identical accuracy but with significantly lower computational costs, making them a practical choice for real-world RF applications. These improvements highlight the scalability and robustness of SSM-based encoders for radar and RF signal processing systems

These results validate that the SSM-based TENNs encoder may effectively classify radar signals without requiring WVD preprocessing, unlike traditional CNN-based approaches. Since the dataset was generated following the MATLAB's radar waveform tutorial, this experiment enables direct comparison with CNN models trained on WVD spectrograms. While CNNs rely on spectrogram preprocessing for feature extraction, the TENN model learned directly from the raw I/Q baseband samples, demonstrating its ability to capture both temporal and spectral characteristics without handcrafted feature engineering. This suggests that SSM-based TENN architectures may serve as a computationally efficient alternative to CNN-based radar signal classification while maintaining competitive accuracy.

In experimental evaluations conducted on radar waveform datasets, CNN-based classifiers trained on time-frequency representations exhibited sensitivity to initialization and hyperparameter selection. In contrast, the SSM-based temporal neural network converged reliably when trained directly on raw I/Q baseband sequences under comparable optimization settings. These observations suggest that structured state-space temporal modeling may provide stable feature learning for radar waveform classification without reliance on large-scale image-domain pretraining.

TENNs have the advantage of their ability to train efficiently on GPUs using parallel processing, unlike RNNs, which require sequential computations that limit scalability. RNNs process sequences step by step, making them inherently difficult to parallelize, leading to higher training times and increased computational overhead. In contrast, TENNs leverage structured SSMs that allow matrix-based updates, enabling efficient parallel computation across long sequences. This architecture eliminates the bottleneck of sequential dependencies, significantly accelerating training and inference, especially for long-range temporal modeling tasks. The ability to harness GPU parallelism makes TENNs well-suited for real-time applications in radar, wireless communication, and autonomous systems, where processing large volumes of sequential data with minimal latency is essential.

An aTENNuate model (a specific instance of TENN) demonstrates low latency processing capabilities by converting temporal convolution layers into equivalent recurrent layers for inference. This allows TENNs to operate efficiently on edge devices and mobile platforms with minimal latency and memory. Such low latency capabilities are vital for radar systems that require immediate processing and decision-making, such as missile defense and collision avoidance.

This framework enables real-time processing of radar signals by eliminating the need for handcrafted feature extraction methods, such as FFT or WVD, which typically require collecting a sufficient number of signal samples before transformation. Instead, the model directly processes the raw in-phase and quadrature baseband signals, allowing for immediate feature extraction without waiting for batch aggregation. This significantly reduces preprocessing latency and makes the system more responsive in real-world applications. Additionally, during inference, the temporal convolution layers used in training may be converted into equivalent recurrent layers, enabling efficient sequential processing without the overhead of storing large time windows of data. This transformation allows the model to operate with minimal buffering, making it particularly well-suited for mobile and embedded radar systems, where computational resources are limited. By leveraging this efficient state-space representation, the framework ensures low-latency decision-making, allowing for real-time modulation classification, target detection, and tracking in high-speed, dynamic environments such as autonomous navigation, defense radar, and spectrum monitoring.

TENNs may process raw signal waveforms directly, avoiding the need for handcrafted preprocessing steps such as time-frequency transformations, which introduce additional latency. The aTENNuate model showcases how TENNs may enhance raw signals directly, maintaining high fidelity and generalizing well to different environments, even under severe signal degradation. This indicates that TENNs may potentially handle diverse radar signal conditions, improving robustness and adaptability compared to traditional deep learning models.

In evaluating the performance of CNN AMC using WVD preprocessing, the model failed to converge when trained without ImageNet initialization, highlighting its dependence on pre-trained weights for feature extraction. FIG. 5A shows a confusion matrix for evaluating the performance of a classification model based on TENN without pretrained weights. The confusion matrix summarizes the relationships between the predicted class labels generated by the machine learning model and the reference class labels provided by an evaluation dataset. The rows of the confusion matrix correspond to reference class labels (the true labels), and the columns correspond to predicted class labels. When training the CNN model without pretrained weights, a CNN that did not train with Barker and was incorrect in its classification. In contrast, TENN converged successfully without pre-trained weights, demonstrating its ability to learn directly from raw radar signals without extensive external training. This result underscores a key advantage of TENNs over CNNs in radar signal processing: their inherent ability to efficiently extract meaningful temporal features from sequential data, eliminating the need for large-scale pretraining. This makes TENNs particularly suitable for real-time and domain-specific applications, where pre-trained models may not be available or applicable, further reinforcing their adaptability and robustness in low-data and signal-specific scenarios.

SSM-based TENNs provide a highly efficient and scalable solution for radar and RF signal processing. By leveraging the structured representation of sequential data, they offer advantages in modulation classification, noise reduction, anomaly detection, and efficient feature extraction. Their ability to model long-range dependencies with linear complexity makes them a superior alternative to traditional deep learning architectures for real-time radar applications. Example implementations demonstrate significant advancements in using SSM-based architectures for radar signal classification, particularly in AMC.

### Real-Time Speech Enhancement

In an example implementation, a TENN was used to implement a deep state-space model, named the aTENNuate network, for real-time denoising of raw speech waveforms, according to some disclosed embodiments. By virtue of being a state-space model, the model was capable of capturing long-range temporal relationships present in speech signals, with stable linear recurrent units. As discussed herein, learning long-range correlations can be useful for capturing global speech patterns or noise profiles, and perhaps implicitly capture semantic contexts to aid speech enhancement performance.

Speech enhancement is important for improving both human-to-human communication, such as in hearing aids, and human-to-machine communication, as seen in automatic speech recognition (ASR) systems. The most challenging task of speech enhancement is removing background noises from speech signals. The complexity of speech patterns and the unknown characteristics of noise poses challenges, further exacerbated by the dense data samples in audio signals and the sensitivity of human perception to minor noise and distortions. Traditional speech enhancement methods such as Wiener filtering, spectral subtraction, and principal component analysis have shown reasonably satisfactory performance in stationary noise environments, but their effectiveness is often limited in non-stationary noise scenarios, resulting in artifacts such as musical noises and substantial degradation in both the quality and intelligibility of the enhanced speech.

Deep learning audio denoising methods are trained on large datasets of clean and noisy audio pairs, and attempt to capture the nonlinear relationship between the noisy and the clean signal features without prior knowledge of the noise statistics, as required by traditional denoising method. Speech features can be extracted from real or complex spectrograms of the noisy signal in the time-frequency domain, or the raw waveform. Many state-of-the-art deep learning denoising models lever-age the feature extraction capability of convolutional networks. The UNet convolutional encoder-decoder is a network architecture used in denoising models exemplified by Deep Complex UNet and the generative adversarial SEGAN. However, CNNs lack the capabilities to model long-range temporal dependencies present in speech signals. Another class of models that are more capable in this regard are RNNs, examples of which are Deep COMplex Convolution Recurrent NEtwork (DCCRN) and Frequency Recurrent Convolution Recurrent Network (FRCRN). These discriminative models show limited robustness to different types of noise and generalization across diverse audio sources. Likelihood-based generative models such as Denoising Diffusion Probabilistic Models (DDPMs) that treat denoising as a conditional generation problem have attempted to overcome the limitations of their discriminative counterparts in generalization to unseen situations. DDPMs, along with Variational autoencoders also belong to the unsupervised class of models promising enhanced generalization capability to unseen noise and acoustic conditions. These approaches, however, often result in a large number of parameters which are computationally expensive, and by their nonlinear recurrent nature cannot efficiently leverage parallel hardware (e.g. GPUs) for training.

Alternative approaches such as PercepNet and RNNoise have attempted to reduce network size and complexity by combining traditional speech enhancement methods with deep learning, resulting in smaller models with fewer parameters capable of running in real-time on general-purpose hardware. Similarly, methods that process raw waveform signals aim to maximize the expressive capabilities of deep networks without resorting to costly time-frequency conversions, as demonstrated by DEMUCS a music source separation model in terms of real-time performance. However, the majority of these models cannot perform real-time inference on general-purpose hardware, exemplified by Nvidia's CleanUNet model. Models such as DeepFilterNet have leveraged speechspecific properties such as short-time speech correlations to achieve comparable results.

In an exemplary implementation of the systems and methods described herein, an aTENNuate network addressed real-time speech enhancement, in accordance with some embodiments. The aTENNuate model used an hourglass network with long-range skip connections, similar in form to the Sashimi network for audio generation.

Unlike previous works using state-space models for audio processing, however, the aTENNuate network directly received raw audio waveforms in the −1 to +1 range and outputs raw waveforms as well, with no one-hot encoding or spectral processing (e.g. STFT or iSTFT). During training of the aTENNuate network, the infinite impulse response (IIR) kernels of the SSM layers could be used as long convolutional kernels over the input features, parallelizing processing using techniques such as FFT convolution or associative scan. During inference, the temporal convolution layers could be converted into equivalent recurrent layers for efficient real-time processing on mobile devices, minimizing latency and reducing the need for excessive buffering of data.

As described herein, state-space models are general representations of linear time-invariant (LTI) systems, and they can be uniquely specified by four matrices: A∈R^{h×h}, B∈R^{h×n}, C∈R^{m×h}, and D∈R^{m×n} The first-order ODE describing the LTI system is given as

$${x}^{.} = Ax + Bu , y = Cx + Du , \qquad ( 1 )$$

where u∈Rⁿ is the input signal, x∈R^{h} is the internal state, and y∈R^{m} is the output. Let n>1, m>1, which yields a multiple-input, multiple-output (MIMO) state-space model. In this exemplary implementation the Du term is not used.

The state-space model in its original form describes a continuous-time system, but in the field of digital signal processing, there are standard recipes for discretizing such a system into a discrete-time state-space model. One such method, the zero-order hold (ZOH), was used here. Under this method, discrete-time state-space matrices A and B as follows:

$$\overline{A} = exp ( Δ A ) , \overline{B} = {( Δ A )}^{- 1} \cdot ( exp ( Δ A ) - 1 ) \cdot Δ B . \qquad ( 2 )$$

The discrete state-space model is then given by:

$$x [ t + 1 ] = \overline{A} x [ t ] + \overline{B} u [ t ] , y [ t ] = C x [ t ] \qquad ( 3 )$$

In the context of recurrent neural networks (RNNs), this representation is a linear RNN layer, which allows for efficient online inference and generation (in this case real-time speech enhancement), but at the same time efficient parallelization during training.

The discrete-time impulse response is given as:

$$k [ τ ] = C {\overline{A}}^{τ} \overline{B} , \qquad ( 4 )$$

where τ denotes the kernel timestep. During training, k can be considered the “full” long 1D convolutional kernel with shape (output channels, input channels, length), in the sense that the output y can be computed via the long convolution yj=i ui*kij. By the convolution theorem, this operation can be performed in the frequency domain, which becomes a point-wise product y\hat{ }jf=i uik\hat{ }ijf. The hat denotes the Fourier transform of the signal (with the index f denoting the Fourier modes), which can be efficiently computed via Fast Fourier Transforms (FFTs).

Generally, a diagonal form exists for the state-space model, meaning that typically Ā to be diagonal at the expense of potentially requiring B̅ and C to be complex matrices. Since the original system is a real system, the diagonal Ā matrix can only contain real elements and/or complex elements in conjugate pairs. In this exemplary implementation, a slight loss in expressivity was given up by continuing to restrict B̅ and C to be real matrices and letting A be a diagonal matrix with all complex elements (but not restricting them to come in conjugate pairs). Since the goal is to work with real features, only the real part of the impulse response kernel was used:

$$k [ τ ] = \text{?} ( C {\overline{A}}^{T} \overline{B} ) , \qquad ( 5 )$$

which equivalently in the state-space equation could be achieved by simply letting y[t]=C [symbol] (x[t]). Therefore, while the internal states x may be maintained as complex values, only the real parts were propagated to the next layer.

The parameters {A, B, C, Δ} were allowed to be directly learnable, which indirectly trained the kernel k. No attempts were made to keep the sizes n, h, m were consistent, to allow for more flexibility in feature extraction at each layer, mirroring the flexibility in selecting channel and kernel sizes in convolutional neural networks. The flexibility of the tensor shapes called for careful choice of the optimal order of operations during training to minimize the computational load.

In some embodiments, the SSM parameters may be initialized using a stability-preserving parameterization. The real part [symbol] (A) may be parameterized as −softplus(a_r), where a_r may be initialized with a value such as −0.4328, giving [symbol] (A)=−½ initially. Due to the positivity of the softplus function, [symbol] (A) may remain negative during training, which may ensure stability of the SSM layer. The imaginary part [symbol] (A) may be parameterized directly and initialized with π(i−1) where i is the state index. The discretization step A may be initialized with 0.001×100\hat{ }[i/16], giving a series of geometrically spaced values from 0.001 to 0.1 in blocks of 16. These initializations and parameterizations are not required, and other approaches respecting the stability of the SSM layer may be used.

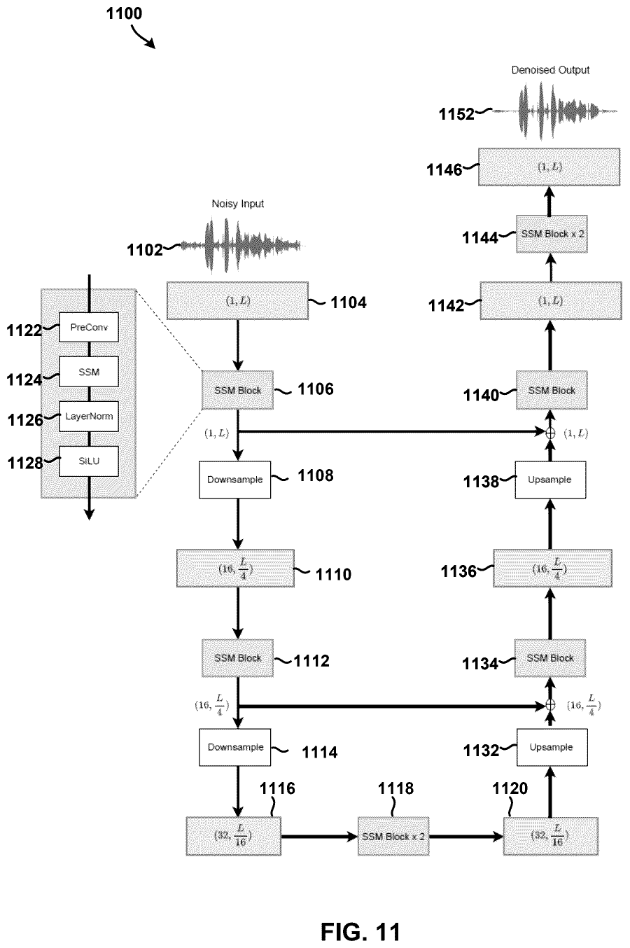

The exemplary implementation of the aTENNuate network used an hourglass network with long-range skip connections, similar in form to the Sashimi network for audio generation. However, unlike previous works using state-space models for audio processing, the aTENNuate network directly received in raw audio waveforms in the −1 to +1 range and outputs raw waveforms as well, with no one-hot encoding or spectral processing (e.g. STFT or iSTFT). The data also retained causality as much as possible for sake of real-time inference, meaning that any form of bidirectional state-space layers were eschewed. The audio features were down-sampled in the encoder and then up-sampled in the decoder, as described herein, with reference to FIG. 11.

As used herein, the term “skip connection” may refer to a direct pathway that connects the output of a layer or block at one stage of a neural network to the input of a corresponding layer or block at a later stage, bypassing one or more intermediate layers. In the context of an encoder-decoder architecture, a skip connection may transfer feature representations from an encoder block to a decoder block operating at a matching resolution level. The skip connection may concatenate or add the transferred features to the features produced by the decoder block. Skip connections may preserve fine-grained information, such as local temporal structure, that may otherwise be lost during downsampling operations in the encoder path. Skip connections may also provide direct pathways for gradient flow during training, which may improve convergence and reconstruction fidelity.

In some embodiments, the optimal contraction order for computing SSM layer operations during training may depend on the dimensions of the tensor operands. If the SSM layer operations are expressed in einsum form, there may be two main ways to compute the output. A first contraction order may involve projecting the input, performing FFT convolution, then projecting the output. A second contraction order may involve computing the full kernel, then performing the full FFT convolution with the input. The first order of contraction may be more optimal when BNF (I+J)<JIF (B+N), where B represents batch size, N represents internal states, F represents Fourier modes (or signal length), I represents input channels, and J represents output channels. Selecting the appropriate contraction order based on tensor dimensions may minimize computational load during training.

For re-sampling, a simple operation was used that squeezed/expanded the temporal dimension and then projected the channel dimension. More formally, for a reshaping ratio of r, a sequence of features could be down-sampled and up-sampled as:

$$Down : ( {C}_{in} , L ) {\to }^{reshape} ( {C}_{in} r , L / r ) {\to }^{project} ( {C}_{out} , L / r ) \qquad ( 6 )$$

$$Up : ( {C}_{in} , L ) {\to }^{reshape} ( {C}_{in} / r , Lr ) {\to }^{project} ( {C}_{out} , Lr )$$

The baseline network used LayerNorm layers and SiLU activations. In addition, a “PreConv” layer was included as a depthwise 1D convolution layer with a kernel size of 3, to enable better processing of local temporal features. The PreConv operation was omitted in the 2 SSM blocks in the neck and in any block with only one channel. To better support mobile devices, the implementation also tested variants of the network with BatchNorm layers4, ReLU activations, and omitting PreConv layers in the decoder (and omitting PreConv layers altogether).

In some embodiments, the theoretical latency of the network may be determined from the product of the resampling factors when the network does not include non-causal convolutional layers. For a network with a total resampling factor of 256 and an input signal sample rate of 16000 Hz, the latency of the network may be at least 256/16000 Hz=16 milliseconds. In the presence of PreConv layers, which may be centered convolutional layers with kernel sizes of 3, additional latencies may be introduced due to the non-causal nature of the convolutions. The additional latency may correspond to the look-forward timestep of the kernel, or the step size of the input features at each layer where a PreConv is applied. Using causal convolutions for PreConv layers may eliminate these additional latencies.

FIG. 11 provides a schematic flow diagram illustrating an SSM-based encoder-decoder architecture of the aTENNuate network system 1100 used to process audio signals in this exemplary implementation, in accordance with some embodiments disclosed herein. The system 1100 can be substantially similar in structure and/ore function to the systems 100, 200, 300, and/or 400, described herein.

FIG. 11 illustrates a system 1100 showing an SSM-based encoder-decoder architecture downsampling encoder path and an upsampling decoder path for signal processing in accordance with some embodiments. The components of the system 1100 may be substantially similar in structure and/or function to the components of system 400 described with reference to FIG. 4. The system 1100 may include a raw input signal 1102, a downsample block 1108, an SSM block 1112, a downsample block 1114, an intermediate tensor 1116, an SSM block set 1118, an upsample block 1138, an SSM block 1140, an intermediate tensor 1142, an SSM block set 1144, an output tensor 1146, and a denoised output 1152.

The encoder path of the system 1100 may receive and progressively downsample the raw input signal 1102. The raw input signal 1102 may include raw audio waveforms in a normalized range without requiring spectral preprocessing such as STFT or iSTFT. In some implementations, the raw input signal 1102 may be substantially similar to the raw signal input 402. The downsample block 1108 may receive the raw input signal 1102 and may reduce the temporal resolution while increasing the channel dimension using a learned resampling operation. The downsample block 1108 may be substantially similar to the downsample layer 408. The downsample block 1108 may apply a trainable projection matrix to reduce sequence length by a resampling factor while mapping input channels to output channels.

The SSM block 1112 may receive the output from the downsample block 1108 and may apply a structured state transition operation across the time dimension. The SSM block 1112 may be substantially similar to the SSM block 406. The SSM block 1112 may include a PreConv layer, an SSM layer, a LayerNorm layer, and a SiLU activation to process temporal features. The downsample block 1114 may further reduce the temporal dimension and increase the channel count. The downsample block 1114 may be substantially similar to the downsample layer 414. The intermediate tensor 1116 may represent the encoded feature representation at a reduced temporal resolution with increased channel dimensions. The intermediate tensor 1116 may be substantially similar to the encoder output tensor 416. The SSM block set 1118 may apply one or more additional SSM blocks to further process the sequence representation before a bottleneck stage. The SSM block set 1118 may be substantially similar to the post-encoder SSM block set 418.

The decoder path of the system 1100 may progressively upsample the bottleneck representation to reconstruct the output signal. The decoder path may be symmetric to the encoder path, with upsample blocks corresponding to downsample blocks and SSM blocks processing temporal dependencies at each resolution level. The upsample block 1138 may receive the bottleneck representation and may increase the temporal resolution while reducing the channel dimension using a learned inverse transformation. For a reshaping ratio of r, the upsample block 1138 may reshape the input features from (C_in, L) to (C_in/r, L*r) and then apply a learned projection to map to (C_out, L*r), thereby expanding the temporal dimension while projecting the channel dimension. The upsample block 1138 may apply a trainable projection matrix that performs the inverse operation of the downsample blocks in the encoder path, enabling reconstruction of higher-resolution temporal features from the compressed bottleneck representation.

The SSM block 1140 may receive the output from the upsample block 1138 and may apply a structured state transition operation to the upsampled features, processing temporal dependencies in the decoder path. The SSM block 1140 may include a PreConv layer, an SSM layer, a LayerNorm layer, and a SiLU activation, mirroring the structure of the SSM blocks in the encoder path. The SSM block 1140 may capture long-range temporal correlations in the upsampled features to refine the reconstructed signal representation. The intermediate tensor 1142 may represent the partially reconstructed feature representation at an intermediate temporal resolution, with reduced channel dimensions compared to the bottleneck and increased temporal resolution compared to the encoder output.

The SSM block set 1144 may apply one or more additional SSM blocks to further refine the reconstructed sequence representation. The SSM block set 1144 may process the intermediate tensor 1142 to enhance temporal coherence and reduce artifacts in the reconstructed signal. The output tensor 1146 may represent the final feature tensor before generating the output waveform, with temporal resolution restored to match the input signal and channel dimension reduced toward the output dimension.

The system 1100 may include long-range skip connections between corresponding encoder and decoder blocks to preserve fine-grained temporal information during reconstruction. The skip connections may concatenate or add encoder features to decoder features at matching resolution levels, allowing the decoder to access high-resolution details that may be lost during downsampling in the encoder path. The skip connections may improve reconstruction fidelity by providing direct pathways for gradient flow during training and preserving local temporal structure during inference.

The denoised output 1152 may provide the enhanced or denoised signal reconstructed from the decoder path. The denoised output 1152 may include raw audio waveforms in the same normalized range as the raw input signal 1102, without requiring post-processing in the spectral domain. The hourglass architecture with skip connections may allow the system 1100 to capture long-range temporal dependencies in the bottleneck while maintaining high fidelity to the original signal structure through the skip connections. The system 1100 may process raw waveforms directly, enabling end-to-end signal enhancement without requiring time-frequency transformations such as STFT or iSTFT.

In some embodiments, the encoder-decoder architecture may include a specific block configuration. As an example, the encoder may include six blocks with resampling factors of 4, 4, 2, 2, 2, and 2, and output channels of 16, 32, 64, 96, 128, and 256, respectively. The neck or bottleneck may include two blocks with a resampling factor of 1 and 256 channels. The decoder may include six blocks mirroring the encoder with resampling factors of 2, 2, 2, 2, 4, and 4, and output channels of 128, 96, 64, 32, 16, and 1, respectively. The output stage may include two blocks with a resampling factor of 1 and 1 channel. For all blocks, the hidden state dimension of the SSM layer may be fixed to h=256. The PreConv operation may be omitted in the neck blocks and in blocks with only one channel to reduce latency during real-time processing.

In the exemplary implementation, the model was trained on the freely available corpus of speech data VCTK with English speakers using various accents and body of audiobooks from LibroVox with data from European speakers from the Microsoft DNS Challenge. The data thus obtained was randomly mixed with noise samples from Audioset, Freesound, and DEMAND. The denoising performance was evaluated on the Voicebank+DEMAND (VB-DMD) testset, and the Microsoft DNS1 synthetic test set (with no reverberation). To guarantee no data leakage between the training and testing sets, clean and noise samples used to generate the synthetic testing samples were removed from the training set. Both the input and output signals of the network were set at 16000 Hz. The loss function was a mix of SmoothL1Loss and spectral loss at the ERB scale.

The model was trained for 500 epochs, AdamW optimizer with a learning rate of 0.005 and a weight decay of 0.02, augmented with a cosine decay scheduler with a linear warmup of 0.01 of the total training steps. Each epoch contained the full VCTK training set, a random subset of the LibroVox training set (of ratio 0.1). To synthesize random noisy samples on the fly as inputs to the network, the clean samples were mixed randomly with the noise samples, with SNR values uniformly sampled from −5 dB to 15 dB.

The evaluation metric was the average wideband PESQ score between the clean signals and the denoised outputs. The term “PESQ” (Perceptual Evaluation of Speech Quality) may be used herein to refer to an objective metric for evaluating the quality of speech signals by measuring the perceptual similarity between a reference clean signal and a processed or denoised signal. The wideband PESQ score may provide an assessment of speech quality across a broader frequency range, making it suitable for evaluating audio signals sampled at higher rates. In some embodiments, the PESQ score may be used to evaluate the performance of the SSM-based encoder-decoder architecture for speech enhancement or denoising tasks. While the PESQ score may provide a quantitative measure of speech quality, it may not fully capture all perceptual aspects of the enhanced signal, such as the presence of low-frequency artifacts or robotic tones. Accordingly, additional evaluation methods such as spectrogram comparison may be used in conjunction with the PESQ score to assess the quality of denoised outputs and verify that the enhanced signal maintains high fidelity to the original clean signal without unnatural artifacts.

The PESQ scores for different variants of the aTENNuate model against other real-time audio-denoising networks are reported in Table. I.

TABLE I
COMPARING DIFFERENT VARIANTS OF THE
ATENNUATE NETWORK AGAINST OTHER REAL-
TIME AUDIO DENOISING NETWORKS. IN TERMS
OF PERFORMANCE, MEMORY/COMPUTATIONAL
REQUIREMENTS, AND LATENCY.

| | | PESQ | | | |
|---|---|---|---|---|---|
| | PESQ | (DNS1 | | | |
| | (VB- | no- | Param- | MACs/ | |
| Model | DMD) | reverb) | eters | sec | Latency |
| DeepFilterNet3 | 3.16 | 2.58 | 2.13M | 0.344 G | 40 ms |
| [22] | | | | | |
| DEMUCS [20] | 2.56 | 2.65 | 33.53M^{a} | 7.72 G^{a} | 40 ms |
| PercepNet [18] | 2.73^{b} | — | 8.00M | 0.80 G | 40 ms |
| RNNoise [19] | 2.43 | 1.94 | 0.06M | 0.04 G | 20 ms |
| aTENNuate | 3.27 | 2.98 | 0.84M | 0.33 G | 46.5 ms |
| (base) | | | | | |
| PreConvs only | 3.21 | 2.84 | 0.84M | 0.33 G | 31.25 ms |
| in encoder | | | | | |
| no PreConvs | 3.06 | 2.59 | 0.84M | 0.33 G | 16 ms |
| BatchNorm + | 2.84 | 2.43 | 0.84M | 0.33 G | 16 ms |
| ReLU | | | | | |

^{a}These numbers are estimated by passing a one-second segment of data to the model.
^{b}This metric is taken directly from the paper as an official implementation of the model does not exist.

As seen in Table I, the PreConv layers (being depthwise) did not affect parameters and MACs but may have added considerable latency. Also reported are other network inference metrics including parameters, MACs, and latencies. For the latency metric, the theoretical latency of the network was the focus, not accounting for any processing latencies. In simpler terms, it was the maximum time range that the network had to “wait” or look-forward to produce a denoised data point corresponding to the current input. Other common speech-enhancement metrics are reported in Table II.

TABLE II
VARIOUS SPEECH ENHANCEMENT METRICS
FOR THE BASE ATENNUATE NETWORK.

| Testset | PESQ | CSIG | CBAK | COVL | SI-SDR |
|---|---|---|---|---|---|
| VB-DMD\| | 3.27 | 4.57\| | 2.85 | 3.96 | 15.04 |
| DNS1 | 2.98 | 4.28 | 3.55 | 3.57 | 15.40 |

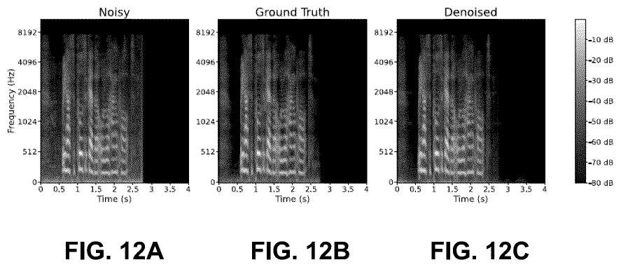

For further inspection of the quality of the denoised samples produced by the network, operators listened to the denoised samples (on both synthetic data and real recordings). Also provided in FIG. 12A-12C is a comparison of the denoised spectrogram and the clean spectrogram for evaluation, to ensure that the denoised samples did not contain any unnatural artifacts that may occur with raw audio processing systems but not captured by the PESQ score.

FIGS. 12A, 12B, and 12C present spectrogram representations for evaluating the denoising performance of the SSM-based encoder-decoder architecture used in the exemplary implementation described with reference to FIG. 11. FIG. 12A shows the spectrogram of a noisy input signal containing background noise and interference. FIG. 12B shows the spectrogram of the clean ground truth signal representing the target output. FIG. 12C shows the spectrogram of the denoised output generated by the system 1100. The spectrograms display frequency on the vertical axis and time on the horizontal axis, with intensity representing spectral energy at each time-frequency location.

The comparison of FIGS. 12A, 12B, and 12C demonstrated that the denoised output closely matches the ground truth signal despite not using any pre-processing or post-processing in the spectral domain. Besides minor low-frequency artifacts that may appear in silent regions, the denoised output maintained high fidelity to the clean ground truth signal. The visual comparison supplemented the PESQ score evaluation to verify that the enhanced signal did not contain unnatural artifacts that may be common with raw audio processing systems but may not be captured by objective metrics alone. The spectrogram comparison confirmed that the SSM-based encoder-decoder architecture preserves the temporal and spectral structure of the original speech signal while effectively suppressing background noise.

Additionally, studies were conducted on the ability of the aTENNuate network to perform super-resolution and de-quantization on highly compressed data. This involved intentionally performing down-sampling and quantization of the input signals, in that order, and re-training the network to handle the degraded/compressed inputs. To use the same network architecture to interface with down-sampled audios, repeats of the input signals were interleaved to restore the original sample rate. For quantization, mu-law encoding was performed on the input signals down to the desired bitwidth, then the quantized signal was rescaled back to the −1 to +1 range. The super-resolution and de-quantization results are reported in Table. III. Note that the outputs were still evaluated against clean signals at 16000 Hz and full precision.

TABLE III
THE AVERAGE PESQ SCORES OF THE MODEL
OUTPUTS WHEN THE NOISY INPUTS ARE
DOWN-SAMPLED AND QUANTIZED.

| Input Type | VoiceBank | DNS1 |
|---|---|---|
| 8000 Hz & 8 bit | 3.19 | 2.88 |
| 4000 Hz & 8 bit | 3.04 | 2.72 |
| 8000 Hz & 4 bit | 2.90 | 2.55 |
| 4000 Hz & 4 bit | 2.72 | 2.39 |

In some embodiments, the network may be made more mobile-friendly through sparsification and quantization of network weights and activations. Sparsification may involve pruning network connections or setting weights below a threshold to zero, reducing the number of active parameters during inference. Quantization may involve reducing the precision of weights and activations from floating-point representations to lower bit-width fixed-point representations, such as 8-bit or 4-bit integers. In some embodiments, a low-rank realization of the state-space matrices may be used to reduce the parameter count, as the state-space matrices may form the majority of the parameter count in the network. State-space models may also be adaptable for spiking implementation on neuromorphic hardware, which may further reduce the power required for the solution. A spiking neural network realization of the SSM-based encoder-decoder architecture may enable deployment on neuromorphic processors with reduced energy consumption compared to conventional digital implementations.

In some embodiments, causal convolutions may be used for PreConv layers to eliminate additional latencies introduced by non-causal convolutions. Causal convolutions may process only current and past samples without requiring future samples, enabling real-time processing without look-ahead buffering. In some embodiments, variants of the network may use BatchNorm layers instead of LayerNorm layers to better support mobile devices. Since BatchNorm is a static form of normalization during inference, the normalization statistics and the affine parameters may be folded into the weights and biases of the previous layer, meaning that the BatchNorm layer does not need to be materialized during inference. In some embodiments, ReLU activations may be used instead of SiLU activations. In some embodiments, PreConv layers may be omitted in the decoder, or PreConv layers may be omitted altogether, to reduce latency and computational requirements while maintaining acceptable signal enhancement performance.

In the exemplary implementation, a lightweight deep state-space autoencoder, aTENNuate, was configured and used to perform raw audio denoising, super-resolution, and de-quantization. Compared to previous works, the key features of this network, in accordance with some embodiments disclosed herein, were: (1) including state-space layers that can be efficiently trained and configured for inference, (2) allowing for real-time inference with low latency, (3) architecturally simple and light in parameters and MACs, (4) capable of processing raw audio waveforms directly without requiring pre/post-processing, and (5) highly competitive with other speech enhancement solutions.

The embodiments disclosed in this application may address various technical challenges associated with high memory traffic and high latency during radar processing of long I/Q sequences. In some embodiments, the processing system may receive digital I/Q baseband samples and may generate an intermediate sequence with a SSM. In some embodiments, the processing system may apply a learned downsampling transformation that reduces sequence length and maps input channels to output channels. In some embodiments, the processing system may generate a latent representation with a temporal neural network integrated with the SSM and may generate an inference result from the latent representation. In some embodiments, the processing system may show a 35% to 70% drop in off-chip memory traffic through DRAM bus counters relative to a matched radar pipeline without the learned downsampling transformation. In some embodiments, the processing system may show a 25% to 55% drop in median inference latency through timestamp counters and a 20% to 45% drop in board energy per inference through power-rail telemetry relative to the matched radar pipeline. In some embodiments, the processing system may lower buffer depth and accelerator bandwidth demand through the learned downsampling transformation and may lower arithmetic count through the latent representation.

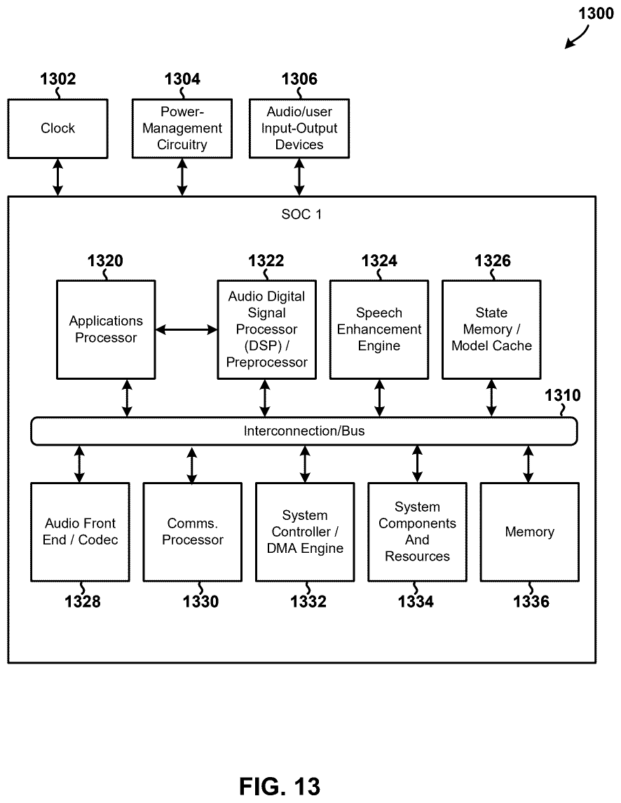

Various embodiments may be implemented in single-processor or multiprocessor computing systems, including a system-on-chip (SoC) or system-in-package (SiP). FIG. 13 illustrates an example edge-device computing architecture 1300 configured to perform online raw-speech enhancement using a deep state-space autoencoder in resource-constrained devices, such as mobile telephones, headsets, earbuds, conferencing devices, smart speakers, vehicle systems, and other edge devices that capture, transmit, store, or render speech.

In the example illustrated in FIG. 13, the SoC 1300 may be coupled to a clock 1302, power-management circuitry 1304, and audio/user input-output devices 1306, such as one or more microphones, speakers, headsets, or other user-interface devices. The SoC 1300 may include an applications processor 1320, an audio digital signal processor (DSP)/preprocessor 1322, a speech enhancement engine 1324 configured to execute the deep state-space autoencoder described herein, a state memory/model cache 1326, an audio front end/codec 1328, a communications processor 1330, a system controller/direct-memory-access (DMA) engine 1332, system components and resources 1334, and memory 1336. The components may communicate via an interconnect/bus 1310, which may include one or more buses, networks-on-chip, or other on-chip communication fabrics.

During operation, microphone signals received through the audio/user I/O devices 1306 may be digitized, conditioned, or coded by the audio front end/codec 1328 and transferred over the interconnect/bus 1310 to the audio DSP/preprocessor 1322 and/or the speech enhancement engine 1324. In some embodiments, the audio DSP/preprocessor 1322 performs low-latency audio operations such as channel selection, sample-rate conversion, synchronization, buffering, echo-reference alignment, gain adjustment, or other pre-processing and post-processing operations. The speech enhancement engine 1324 may process the raw waveform, or blocks thereof, in an online manner to generate an enhanced speech waveform. The enhanced output may be returned to the audio front end/codec 1328 for playback or local recording, and/or provided to the communications processor 1330 for uplink transmission to a remote endpoint.

The speech enhancement engine 1324 may be implemented using dedicated logic, one or more neural processing cores, one or more DSP cores, one or more central processing cores, or any combination thereof. The applications processor 1320 may configure operating modes, load or select model parameters, manage user applications, and supervise invocation of the speech enhancement engine 1324. The state memory/model cache 1326 may store model weights, recurrent or state-space variables, intermediate activations, streaming buffers, and other data used by the speech enhancement engine 1324 so that the model may preserve temporal context across successive input samples, frames, or blocks without reprocessing an entire utterance.

Each of the applications processor 1320, audio DSP/preprocessor 1322, speech enhancement engine 1324, and communications processor 1330 may include one or more cores or processing elements. In some embodiments, processing associated with the disclosed model may be partitioned across a heterogeneous processing cluster. For example, a first processor may manage audio input/output and session control, a second processor may perform pre-processing and post-processing, and a third processor may execute at least a portion of the deep state-space autoencoder. Such partitioning may reduce latency and power consumption while supporting continuous or near-continuous speech enhancement in battery-powered devices.

The system controller/DMA engine 1332 and the system components and resources 1334 may manage movement of audio samples, state vectors, coefficients, and output buffers among the audio front end/codec 1328, the audio DSP/preprocessor 1322, the speech enhancement engine 1324, the state memory/model cache 1326, and the memory 1336. The system components and resources 1334 may include, for example, memory controllers, peripheral bridges, interrupt controllers, timers, oscillators, phase-locked loops, regulators, security circuitry, and other support circuitry used to coordinate real-time execution of the disclosed speech enhancement operations.

The memory 1336 may include on-chip SRAM, cache memory, non-volatile memory, off-chip DRAM, or combinations thereof. In some embodiments, the state memory/model cache 1326 is implemented using low-latency on-chip memory to store a current latent state, a hidden state, one or more convolution or state-space histories, overlap/add buffers, and/or quantized or non-quantized model parameters. By storing only a current state and a limited amount of recent context, the SoC 1300 may perform streaming enhancement with bounded latency and reduced memory usage.

An input/output module, which may be implemented as part of the audio front end/codec 1328 and/or the system components and resources 1334, may interface with external resources, including the clock 1302, power-management circuitry 1304, the audio/user I/O devices 1306, wired audio interfaces, and wireless transceivers. Accordingly, the SoC 1300 may be used in devices that locally enhance speech before playback, storage, transmission, speaker recognition, automatic speech recognition, or other downstream processing.

In some embodiments, the speech enhancement engine 1324 implements a deep state-space autoencoder configured to perform end-to-end denoising of raw speech waveforms. The model may be trained to reconstruct clean speech from noisy speech and may optionally be used for related restoration tasks such as bandwidth extension, super-resolution, and de-quantization. Compared with conventional real-time denoising models, the disclosed model may provide improved perceptual quality with reduced parameter count, reduced multiply-accumulate operations, and lower inference latency, thereby enabling deployment in resource-constrained edge devices.

Because the disclosed architecture operates directly on raw waveforms while preserving compact state information across time, the SoC 1300 may maintain high fidelity to clean speech, suppress background noise, and reduce audible artifacts. The architecture may also process compressed, low-sample-rate, and/or reduced-bit-depth inputs, including in some examples audio sampled at about 4000 Hz and represented with about 4-bit resolution. The disclosed architecture may support efficient online speech enhancement in constrained computing environments.

All or portions of some embodiments may be implemented in the cloud or on a variety of commercially available computing devices. A server device may include a SoC or one or more processors (e.g., multi-core processor, etc.) coupled to memory, storage interfaces such as USB ports and NVMe slots, and network access ports that allow data connections through a network interface card (NIC) and a communication network (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Severs 900 often include multiple processors, with dedicated processors for specific tasks such as managing cloud computing operations, data analytics, or wireless communication functions. Software applications may be stored in the internal memory before being accessed and executed by the processor. Modern processors may include extensive internal memory, often augmented with fast access cache memory, to efficiently store and process application software instructions.

Implementation examples are described in the following paragraphs. While some of the following implementation examples are described in terms of example methods, further example implementations may include: the example methods discussed in the following paragraphs implemented by a computing system including a processor configured (e.g., with processor-executable instructions) to perform operations of the methods of the following implementation examples; the example methods discussed in the following paragraphs implemented by a computing system including means for performing functions of the methods of the following implementation examples; the example methods discussed in the following paragraphs may be implemented as a non-transitory processor-readable storage medium having stored thereon processor-executable instructions configured to cause a processor of a computing system to perform the operations of the methods of the following implementation examples; and the example methods discussed in the following paragraphs may be implemented as a non-transitory processor-readable storage medium having stored thereon data and configurations to control a state machine or cause a processor to perform the operations of the methods of the following implementation examples.

Example 1: A radar signal processing system including: radar receiver configured to receive reflected radar signals and convert said signals into in-phase and quadrature baseband samples; and a processing module including a temporal neural network (e.g., TENNs, etc.) integrated with SSM, configured to receive and process said I/Q baseband samples for tasks including AMC, signal detection, and target identification.

Example 2: The radar signal processing system of example 1, wherein said temporal neural network utilizes an SSM-based encoder to extract compact feature representations from I/Q baseband signals, enabling long-range dependency modeling, efficient noise filtering, and improved robustness in dynamic radar environments.

Example 3: The radar signal processing system of example 1, wherein said temporal neural network performs AMC by learning structured representations of radar waveforms, allowing accurate differentiation between modulation types.

Example 4: The radar signal processing system of example 1, wherein said processing module dynamically adapts its signal processing strategies based on real-time environmental conditions, including SNR fluctuations, multipath interference, and adversarial electronic warfare countermeasures.

Example 5: The radar signal processing system of example 1, wherein said temporal neural network-based encoder is trained using supervised on datasets including real and synthetic I/Q radar waveforms, ensuring robust generalization to new signal environments.

Example 6: A method for processing radar signals, including receiving radar signals and converting them into in-phase and quadrature baseband samples, processing the I/Q baseband samples using a temporal neural network integrated with SSM, extracting structured representations from radar waveforms using the SSM-based encoder to facilitate modulation classification, detection, and target classification, classifying modulation types using said temporal neural network by analyzing learned patterns in raw I/Q sequences, and identifying radar targets based on SSM of micro-Doppler signatures.

Example 7: The method of example 6, wherein said temporal neural network-based encoder is deployed on low-power embedded hardware or real-time radar processing units, enabling real-time inference with minimal computational overhead compared to traditional deep learning architectures.

Example 8: A radar signal processing system as described in example 1, wherein the downsampling mechanism is implemented using a structured state-space transformation, including:

Example 9: An SSM-based encoder that first extracts temporal dependencies from the input in-phase and quadrature baseband signals, ensuring key features are preserved before downsampling.

Example 10: A learned resampling operation, wherein a transformation matrix maps the input feature space from an initial temporal resolution to a reduced representation, optimizing computational efficiency while retaining essential spectral and temporal characteristics of the radar waveform.

Example 11: A trainable projection matrix applied via Einstein summation notation, which performs channel-to-channel transformation while reducing the sequence length by a resampling factor, thereby enabling adaptive downsampling that is optimized for radar signal classification and target recognition.

Example 12: A method for converting temporal convolution layers into equivalent recurrent layers during inference, ensuring real-time processing with minimal latency and reducing memory overhead on embedded and mobile processing units.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A computing system, comprising:
a memory;
a processing system coupled to the memory, wherein the processing system includes at least one processor configured to:
receive a raw input signal;
process the raw input signal through an encoder path comprising:
one or more downsample blocks that reduce a temporal resolution of the raw input signal while increasing a channel dimension using learned resampling operations, and
one or more state space model (SSM) blocks that apply structured state transition operations across a time dimension to generate a bottleneck representation;
process the bottleneck representation through a decoder path comprising:
one or more upsample blocks that increase the temporal resolution while reducing the channel dimension using learned inverse transformations, and
one or more SSM blocks that apply structured state transition operations to refine a reconstructed signal representation;
apply skip connections between corresponding encoder and decoder blocks to preserve fine-grained temporal information during reconstruction; and
generate a denoised output signal from the decoder path, the denoised output signal used for real-time enhancement of the raw input signal.

2. A non-transitory processor-readable storage medium having stored thereon data and configurations to control a state machine or cause a processing system to perform operations comprising:
receiving a raw input signal;
processing the raw input signal through an encoder path comprising:
one or more downsample blocks that reduce a temporal resolution of the raw input signal while increasing a channel dimension using learned resampling operations, and
one or more state space model (SSM) blocks that apply structured state transition operations across a time dimension to generate a bottleneck representation;
processing the bottleneck representation through a decoder path comprising:
one or more upsample blocks that increase the temporal resolution while reducing the channel dimension using learned inverse transformations, and
one or more SSM blocks that apply structured state transition operations to refine a reconstructed signal representation;
applying skip connections between corresponding encoder and decoder blocks to preserve fine-grained temporal information during reconstruction; and
generating a denoised output signal from the decoder path, the denoised output signal used for real-time enhancement of the raw input signal.

3. A method for adaptive control of a radar system based on modulation-type identification from digital in-phase and quadrature (I/Q) baseband samples, the method performed by a computing system coupled to a radar receiver and a radar controller, the method comprising:
receiving, by the computing system, a radar signal comprising digital I/Q baseband samples;
generating, by the computing system and with a state space model (SSM), an intermediate sequence comprising state space model (SSM) output features that represent temporal dependencies of the digital I/Q baseband samples;
downsampling, by the computing system, the intermediate sequence by applying a learned downsampling transformation that reduces a sequence length and maps input channels to output channels to form a downsampled intermediate representation;
generating, by the computing system, a classifier output by providing the downsampled intermediate representation to a classifier;
identifying, by the computing system and from the classifier output, a modulation type associated with the radar signal; and
updating, by the computing system, the radar system by generating radar-control data that specifies at least one of a threshold setting, a dwell allocation, a waveform schedule, and an assignment of resource priority and by providing the radar-control data to the radar controller.

4. A method for processing radar signals, the method performed by a computing system having one or more processors and one or more memories, the method comprising:
receiving a radar signal;
extracting, using a state space model (SSM), a set of features from the radar signal, the set of features including information associated with phase, frequency, amplitude, and a structure of the radar signal;
generating a modified radar signal that includes temporal dependencies included in structure of the radar signal;
downsampling the modified radar signal to generate an intermediate representation of the radar signal;
providing the intermediate representation of the radar signal to a classifier to generate an output;
identifying automatically, based on the output, a modulation type associated with the radar signal; and
sending data to adapt a radar operation, based on the identification of the modulation type associated with the radar signal, the radar operation associated with at least one of a threshold setting, a dwell allocation, a waveform schedule, and assignment of resource priority.

5. The method of claim 4, wherein the generating the modified radar signal includes reducing, using the SSM, a noise associated with the radar signal in the modified radar signal.

6. The method of claim 4, wherein the generating the modified radar signal includes:
identifying if an anomaly is included in the radar signal, and
based on detecting the anomaly, generating a flag indicating the modified radar signal is associated with a potential interference and/or unauthorized transmission.

7. The method of claim 4, wherein:
the classifier is a SSM encoder; or
the SSM is an autoencoder.

8. The method of claim 4, wherein the intermediate representation of the radar signal is generated by an SSM.

9. A computing device, comprising:
a memory;
a processing system coupled to the memory, wherein the processing system includes at least one processor configured to:
receive a signal;
extract, using a state space model (SSM) autoencoder, a set of features from the radar signal, the set of features retaining a structure of the radar signal;
generate a modified radar signal that includes temporal dependencies in the structure of the radar signal;
downsample the modified radar signal to generate an intermediate representation of the radar signal;
provide the intermediate representation of the radar signal to a classifier to generate an output;
identify automatically, based on the output, a modulation type associated with the radar signal; and
send an indication of the identification of the modulation type, the indication configured to induce:
a radar controller to update a sensing mode or a scheduling decision associated with the radar controller,
a tracker to initialize, update, confirm, or suppress a target track, or
a display device to render a label, an alert, a value, or a target icon associated with the signal.

10. A non-transitory processor-readable storage medium having stored thereon data and configurations to control a state machine or cause a processing system to perform operations comprising:
receiving a radar signal;
extracting, using a state space model (SSM), a set of features from the radar signal, the set of features including information associated with phase, frequency, amplitude, and a structure of the radar signal;
generating a modified radar signal that includes temporal dependencies included in structure of the radar signal;
downsampling the modified radar signal to generate an intermediate representation of the radar signal;
providing the intermediate representation of the radar signal to a classifier to generate an output;
identifying automatically, based on the output, a modulation type associated with the radar signal; and
sending data to adapt a radar operation, based on the identification of the modulation type associated with the radar signal, the radar operation associated with at least one of a threshold setting, a dwell allocation, a waveform schedule, and assignment of resource priority.

11. A method for analyzing radar signals using a temporal neural network integrated with a state space model, the method comprising:
receiving in-phase and quadrature baseband samples from a radar receiver;
processing the received in-phase and quadrature baseband samples with a temporal neural network that includes a state space model to extract one or more latent representations;
generating an output that classifies a modulation type or identifies a target based on the one or more latent representations; and
adapting, based on the modulation type or target, a radar operation comprising at least one of adjusting a detection threshold, selecting a waveform from a waveform library, updating a dwell allocation, or modifying a resource priority of the computing system.

12. The method of claim 11, further comprising:
initializing one or more parameters of the state space model by defining at least one transition matrix or at least one observation matrix.

13. The method of claim 11, further comprising:
downsampling the one or more latent representations by applying a learned projection matrix that reduces a temporal dimension of the radar signals and retains amplitude and spectral features.

14. The method of claim 11, wherein the temporal neural network comprises:
an SSM-based encoder that captures extended temporal correlations in the in-phase and quadrature baseband samples and outputs the one or more latent representations to a classifier head.

15. The method of claim 14, further comprising:
applying a decoder to reconstruct the in-phase and quadrature baseband samples from the one or more latent representations for denoising or anomaly detection.

16. The method of claim 14, wherein the classifier head includes one or more fully connected layers that receive the one or more latent representations and produce an output indicating the modulation type or target class.

17. The method of claim 11, further comprising converting one or more temporal convolution operations within the temporal neural network into equivalent recurrent operations during inference, reducing memory usage and enabling real-time analysis on embedded hardware.

18. The method of claim 11, further comprising adapting one or more parameters of the state space model or the temporal neural network based on at least one environmental factor, including changes in signal-to-noise ratio or multipath conditions.

19. The method of claim 11, wherein the temporal neural network includes parallelizable matrix operations that update states of the state space model, allowing simultaneous processing of multiple time steps on a graphics processing unit or equivalent hardware accelerator.

20. The method of claim 11, further comprising training the temporal neural network by providing labeled examples of radar signals, wherein each labeled example comprises a sequence of in-phase and quadrature baseband samples paired with a ground-truth modulation category or target label.

21. The method of claim 13, wherein the learned projection matrix performs downsampling by mapping an input feature space to a reduced representation that preserves time-dependent features relevant for the classification or detection output.

22. The method of claim 12, wherein the one or more parameters of the state space model are updated using an optimization procedure that accounts for long-range dependencies in the received in-phase and quadrature baseband samples.

23. The method of claim 11, further comprising buffering only a limited quantity of incoming in-phase and quadrature baseband samples for conversion to recurrent operations, thereby enabling low-latency processing.

24. The method of claim 11, wherein the output that classifies a modulation type or identifies a target includes generating a confidence score that indicates the likelihood of a particular modulation scheme or target class.

25. The method of claim 11, wherein the radar signals originate from at least one radar platform selected from the group consisting of defence, maritime, weather monitoring, aviation, or autonomous vehicle systems.

26. A non-transitory processor-readable storage medium having stored thereon data and configurations to control a state machine or cause a processing system to perform operations comprising:
receiving in-phase and quadrature baseband samples from a radar receiver;
processing the received in-phase and quadrature baseband samples with a temporal neural network that includes a state space model to extract one or more latent representations;
generating an output that classifies a modulation type or identifies a target based on the one or more latent representations; and
adapting, based on the modulation type or target, a radar operation comprising at least one of adjusting a detection threshold, selecting a waveform from a waveform library, updating a dwell allocation, or modifying a resource priority of the computing system.
